(19) United States
(12) Patent Application Publication
(10) Pub. No.: US 2003/0014624 A1
(43) Pub. Date: Jan. 16, 2003

(54) Non-proxy internet communication

(75) Inventors: Guillermo Maturana, Berkeley, CA (US); Ashish N. Naik, San Jose, CA (US)

Correspondence Address: MICHAEL B. EINSCHLAG, ESQ., 25680 FERNHILL DRIVE, LOS ALTOS HILLS, CA, 94024, US

(73) Assignee: Andes Networks, Inc., Mountain View, CA (US)

(21) Appl. No.: 10/086,090

(22) Filed: Feb. 26, 2002

Related U.S. Application Data
(63) Continuation-in-part of application No. 09/630,330, filed on Jul. 31, 2000.
(63) Continuation-in-part of application No. 09/702,527, filed on Oct. 31, 2000.
(63) Continuation-in-part of application No. 09/792,964, filed on Feb. 26, 2001.

(51) Int. Cl. H04L 9/00

(52) U.S. Cl. 713/151

(57) ABSTRACT

A method for handling an application in a communication between a first end and a second end involving an application layer, a transport layer, and a network layer, which method includes steps of: (a) receiving network layer packets from the first end of the communication, which packets contain application information provided using application layer processing; (b) processing the application information using application layer processing; and (c) transmitting network layer packets toward the second end of the communication, which packets contain information resulting from the application layer processing.

This is a continuation-in-part of: (a) a patent application entitled “State Transition Strategy for Handling Secure Communications,” Ser. No. 09/630,330, filed Jul. 31, 2000; (b) a patent application entitled “Strategy for Handling Dropped Data in Secure Communications,” Ser. No. 09/702,527, filed Oct. 31, 2000; and (c) a patent application entitled “Strategy for Handling Long SSL Messages,” Ser. No. 09/792,964, filed Feb. 26, 2001.

### TECHNICAL FIELD OF THE INVENTION

One or more embodiments of the present invention pertain to method and apparatus for handling communications on the internet. In particular, some embodiments of the present invention relate to method and apparatus for handling communications in a primarily non-proxy mode.

### BACKGROUND OF THE INVENTION

A well known set of protocols, known in the art as Transmission Control Protocol/Internet Protocol (“TCP/IP”) protocols, govern most of an interconnected public network known as the Internet. The TCP/IP protocols conform to an Open Systems International (“OSI”) layered network description wherein: (a) layer 1 is a physical layer that transmits bits of information across a link (it deals with problems such as size and shape of connectors, assignment of functions to pins, conversion of bits to electrical signals, bit-level-synchronization, and so forth); (b) layer 2 is a data link layer that is responsible for transmitting chunks of information across a link (it deals with problems such as checksumming to detect data corruption, coordinating the use of shared media, as in a local area network (“LAN”), and addressing—“Ethernet” is one well known example of a layer 2 protocol); (c) layer 3 is a network layer that enables any pair of systems in the network to communicate with each other (it deals with problems such as route calculation, packet fragmentation and re-assembly when different links in the network have different maximum packet sizes, and congestion control—Internet Protocol (“IP”) is perhaps the most well known example of a layer 3 protocol); (d) layer 4 is a transport layer that establishes a reliable communication stream between a pair of systems (it deals with errors that can be introduced by the network layer, i.e., layer 3, such as lost packets, duplicated packets, packet reordering, and fragmentation and re-assembly so that the user of the transport layer can deal with larger-size messages, and so that less efficient network layer fragmentation and re-assembly might be avoided—Transmission Control Protocol (“TCP”) is perhaps the most well known example of a layer 4 protocol); and (e) layers 5-7 have less clear distinctions in practical network implementations (collectively, layers 5-7 cover the functionality of an operating system and applications, and as such, are much less standardized than layers 1-4). These concepts are described in a book entitled “TCP/IP Illustrated, Volume 1—The Protocols” by W. Richard Stevens, published by Addison-Wesley, 1994, and a book entitled “Interconnections, Second Edition Bridgers, Routers, Switches, and Internetworking Protocols” by Radia Perlman, published by Addison-Wesley, 1999.

As is well known to those of ordinary skill in the art, a transport layer, for example and without limitation, a layer 4 protocol such as TCP, deals with a segment (a TCP segment) that comprises a transport (TCP) header and application data, which application data will be referred to herein as a message or a payload, The application data typically includes user data and an application header. As is further well known to those of ordinary skill in the art, a network layer, for example and without limitation, a layer 3 such as IP, deals with a datagram that comprises a network (IP) header and the TCP segment. As is well known to those of ordinary skill in the art, due to restrictions of a layer 2 implementation, a layer 3 datagram must sometimes be broken up into smaller units of data, i.e., fragments, each of which must be sent separately across the physical wire. This might happen, for example, if an IP datagram were too large to be transmitted over a particular layer 2 link. In this case, each fragment would have a different IP header. Each such unit of transfer at the network layer level will be referred to herein as a packet. Lastly, a link layer, for example and without limitation, a layer 2 protocol such as Ethernet, deals with a frame that comprises a (Ethernet) header, an IP datagram, and a (Ethernet) trailer.

In a TCP/IP connection between a client and a server across a network such as the Internet, information flow is bi-directional, i.e., each unit of data sent across the network has a “sender” (for example, either a client or a server) and a “receiver” (for example, either the server or the client, respectively). As is well known to those of ordinary skill in the art, some characteristics of the transmitted data are linked to the client or server role in a transmission, regardless of the direction of information transmission, and other characteristics of the transmitted data are linked to the sender or receiver role, regardless of whether the sender was the client or the server.

The Internet is presently being used extensively for eCommerce, stock transactions, and other transactions that require security and privacy. To provide such security and privacy, most commercial websites use a security technology provided by the Secure Sockets Layer (“SSL”) protocol.

SSL is a separate protocol used just for security that is inserted between TCP and the Hypertext Transfer Protocol (“HTTP”). By acting as a new protocol, SSL requires very few changes in protocols existing above and below it. In particular, an HTTP application interfaces with SSL nearly the same way it would with TCP in the absence of SSL. And, as far as TCP is concerned, SSL is just another application using its services. Thus, SSL provides a standardized method of adding cryptographic security functions to a TCP-based application such as a web browser. See a book by Stephen Thomas entitled “SSL and TLS Essentials, Securing the Web,” published by John Wiley & Sons, Inc., 2000.

The Internet Engineering Task Force (“IETF” ietf.org) has taken the SSL specification and standardized it in the Transport Layer Security (“TLS”) open standard. Further, the Wireless Application Protocol (“WAP”) standards group has formed a variant of the TLS standard called Wireless Transport Layer Security (“WTLS”), with some additional features for the wireless environment.

In this patent specification, the term SSL refers to any member of this encryption family including, but not limited to, currently popular family members SSL 2.0, SSL 3.0, TLS 1.0, and WTLS 1.1. In addition, in this patent specification, the term Transaction Security refers to the SSL family of encryption standards, as opposed to Network Security as implemented by the IPSec standard. In particular, as used in this patent specification, Transaction Security is performed above layer 4 in a layer 4/layer 3 stack (for example, a TCP/IP stack), whereas Network Security is performed at layer 3 or below.

The SSL protocol defines two different roles for communicating parties. One system is always a client, while the other is a server; the SSL protocol requires the two systems to behave differently. The client is always the system that initiates a secure communication, and the server responds to the client's request. Since the client initiates a communication, it has the responsibility of proposing a set of SSL options to use for the exchange. The server selects from the client's proposed options, deciding which one the two systems will actually use. Although the final decision rests with the server, the server can only choose from among those options that the client has originally proposed.

Whenever SSL clients and servers communicate, they do so by exchanging SSL messages. As is well known to those of ordinary skill in the art, such SSL messages include, in alphabetic order: (a) “Alert,” a message that informs the other party of a possible security breach or communication failure; (b) “ApplicationData,” a message that refers to actual information exchanged by the two parties exchange that is encrypted, authenticated, and/or verified by SSL; (c) “Certificate,” a message that carries the sender's public key certificate; (d) “CertificateRequest,” a message from the server requesting the client to provide its public key certificate; (e) “CertificateVerify,” a message from the client verifying it knows the private key corresponding to its public key certificate; (f) “ChangeCipherSpec,” a message to begin using agreed-upon security services (such as encryption); (g) “ClientHello,” a message from the client indicating the security services it desires and is capable of supporting; (h) “ClientKeyExchange,” a message from the client carrying cryptographic keys for the communications; (i) “Finished,” a message indicating that all initial negotiations are complete and secure communications have been established; j) “HelloRequest,” a message from the server requesting the client to start (or restart) the negotiation process; (k) “ServerHello,” a message from the server indicating the security services that will be used for the communications; (l) “ServerHelloDone,” a message from the server that it has completed all its requests of the client for establishing communications; and (m) “ServerKeyExchange,” a message from the server carrying cryptographic keys for the communications.

The SSL protocol does not exist in isolation. Rather, it depends on additional, lower-level protocols to transport its messages between peers. In all practical implementations, the SSL protocol relies on the TCP protocol. It is critical for the SSL protocol to receive TCP segments in the correct sequence, so it relies on TCP to deliver segments in order. SSL can determine the beginning and end of its own messages without assistance from the transport layer. To mark these beginnings and endings, SSL puts its own explicit length indicator in every message. This explicit length indicator enables SSL to combine multiple SSL messages into single TCP segments. This conserves network resources, and increases efficiency of the SSL protocol.

In one example of an SSL transmission across a TCP/IP network such as the Internet, a client (for example, a web browser on a personal computer) runs an application that generates an SSL message to be sent to a server (for example, an Internet web site running on the server). To send the message, the application sends the SSL message to an SSL handler on the client side of the transmission. The SSL handler on the client side sends a complete SSL message to a TCP/IP stack routine running on the client side of the transmission, which TCP/IP stack routine manages a layer 4 queue and a layer 3 queue. The client side TCP/IP stack routine sends the SSL message to the server. Depending on the particular implementation of the TCP/IP stack routine, the SSL message may be broken up into one or more IP datagrams that are sent individually through a network interface to the Internet. In a typical case, each IP datagram is a single packet that is routed independently across the Internet using standard layer 2 and layer 3 switching technology that is well known to those of ordinary skill in the art. In this typical case, each packet arrives at a server network interface card; and is detected by a TCP/IP stack routine running on the server side of the transmission. As is well known in the art, the server side TCP/IP stack routine detects the arrival of each packet, and assembles the packets, in order, to form the original TCP message. Then, the TCP message is passed to an SSL handler on the server side of the transmission. The SSL handler on the server side waits until the TCP/IP stack routine running on that machine has received the complete SSL message.

As is well known in the art, the SSL handlers on both the client and server side of the communication are unaware of the details of layer 4 and below transmission, including, for example, the number of packets sent, the order in which the packets were sent, the transmission protocols used for the transmission, the occurrence of any dropped packets, any required re-sends of those packets, and so forth.

FIG. 1 shows a diagram of a standard transmission between a client and a server over a network in which agent 103 has been inserted to perform an encryption and decryption function according to an SSL family of security protocols. As shown in FIG. 1, network 102 is a network, for example and without limitation, a public network commonly known as the Internet, and network 104 is a network, for example and without limitation, a private network, most often existing inside a physically secure building such as, for example and without limitation, a co-location facility. In operation, agent 103 receives encrypted traffic sent by client 101 through network 102, decrypts it, and sends it through network 104 to server 105. Conversely, whenever server 105 sends data through network 104 to agent 103, agent 103 encrypts the data, and sends it through network 102 to client 102. Note that unencrypted (i.e., “plaintext”) data appears on network 104. The function of agent 103 was historically integrated into an application running on server 105, for example, an Apache web server, but for performance reasons (due to computationally intense cryptography), the function of agent 103 was separated in the manner shown in FIG. 1.

In current implementations of agent 103 performing SSL family functions, there is a high performance and memory requirement for agent 103 because the connection from agent 103 to client 101, and the connection from agent 103 to server 105 are separate TCP/IP connections. This arrangement is referred to in the art as a “proxy-mode” SSL connection because agent 103 implements a fully-functional TCP/IP stack in order to maintain these two connections. The performance requirements of the complete system are high, and the total number of required, simultaneously active connections is high.

FIG. 2 shows a schematic diagram of conventional information flow from sender 201 to receiver 203. Note that sender 201 may be either a client or a server in a network relationship. As shown in FIG. 2, SSL message handler 210 in sender 201 forms an SSL message, and sends the SSL message to TCP/IP stack routine 206 of sender 201 (stack routine 206 is shown schematically to comprise a layer 4 queue structure and a layer 3 queue structure). TCP/IP stack routine 206 transmits packets 204 out of a network interface (typically, an Ethernet adapter card) at sender 201 onto a network. Packets 204 are received by a network interface (typically, an Ethernet adapter card) at prior art agent 202, and they are assembled and interpreted by TCP/IP stack routine 207 running on agent 202 (stack routine 207 is shown schematically to comprise a layer 4 queue structure and a layer 3 queue structure). TCP/IP stack routine 207 combines packets 204 and resulting TCP segments to form the complete SSL message, and passes the SSL message to SSL function 212 for encryption or decryption (depending on whether the sender is a server or a client, respectively). Next, SSL function 212 sends the resulting encrypted/decrypted message to TCP/IP stack routine 208 (stack routine 208 is shown schematically to comprise a layer 4 queue structure and a layer 3 queue structure). In practice, TCP/IP stack routine 208 may also serve as TCP/IP stack routine 207. TCP/IP stack routine 208 transmits packets 205 out of a network interface at agent 202 onto a network. Packets 205 are received by a network interface at receiver 203, and they are assembled and interpreted by TCP/IP stack 209 running on receiver 203 (stack routine 209 is shown schematically to comprise a layer 4 queue structure and a layer 3 queue structure). TCP/IP stack routine 209 combines packets 205 and resulting TCP segments to form a complete SSL message 211. Note that in this prior art implementation, one or two complete TCP/IP stacks must be running on agent 202 to implement the SSL functionality. Also, because there may be many concurrent SSL sessions being handled, and because packets for each session (shown as packets 204 and packets 205 in FIG. 2) are interleaved with those from other sessions, there must be a large amount of memory present at agent 202 to support the many concurrent sessions.

At present, on a client, SSL is embedded in browsers such as, for example, Netscape and Internet Explorer. Every time a secure site is accessed by such a browser, an SSL session with a server is established. Currently, 5 to 10% of eCommerce traffic is encrypted via SSL, and for a site like eTrade, 100% of registered user service traffic is encrypted. Servers that support these sites can handle thousands of standard http (non-encrypted) transactions per second, but when a secure transaction is needed there is substantial overhead for the server. The overhead comes from establishing an SSL session (this involves thousands of operations associated with cryptography), and from encrypting/decrypting each message during an SSL session. The overhead is such that servers' throughput is reduced significantly.

As discussed above, there are products currently on the market to accelerate SSL transactions, which products decrypt an incoming transaction, and send it to the server “in the clear” (i.e., un-encrypted). Intel offers a “iPivot” box that is claimed to process 200 SSL messages per second, and to increase server throughput by a factor of 50. IBM offers a computer system hosting Rainbow cards that claims to provide 200 SSL messages per second per card. In spite of the above offerings, securing Internet traffic remains inefficient.

In summary then, a traditional approach to processing data from the network is to use OSI network protocol layers, where each layer takes a turn processing a data segment. While this approach makes it easy to implement applications for general-purpose network processing, it is unsuitable for today's specialized high-performance network processors. The main problem is performance overhead, especially for transport layer applications such as those based on TCP. TCP processing involves large time and space overhead on a network processor, most of which is unnecessary for a processor that simply transforms a data-stream on its way from a sender to receiver where the sender and the receiver each has its own transport layer implementation.

Many of today's special-purpose network processors are agents that transform a specific data stream from a sender to receiver to relieve the receiver from doing processing. Specific examples of this processing are SSL processing (discussed above) wherein cryptographic processing required for the SSL protocol is offloaded to a special purpose network processor, and XML/SOAP processing, where a special purpose network processor performs error checks and error correction on XML/SOAP requests instead of having these checks performed by the receiver. As described above, when these special purpose network processors use the entire OSI stack, each packet “goes up” four TCP stacks (as opposed to two, without the network processor). Hence, some of the gains in performance are offset by performance overhead due to additional TCP processing, as well as increased latency due to an additional “hop” between a sender, for example, a client, and a receiver, for example, a server.

As one can readily appreciate from the above, a need exists in the art for method and apparatus that process, for example, encrypt/decrypt, messages sent over a network rapidly, and which do not require large amounts of computational or memory resources.

### SUMMARY OF THE INVENTION

Embodiments of the present invention advantageously satisfy the above-identified need in the art and provide method and apparatus that process messages sent over a network rapidly, and which do not require large amounts of computational or memory resources.

In particular, one embodiment of the present invention is a method for handling an application in a communication between a first end and a second end involving an application layer, a transport layer, and a network layer, which method comprises steps of: (a) receiving network layer packets from the first end of the communication, which packets contain application information provided using application layer processing; (b) processing the application information using application layer processing; and (c) transmitting network layer packets toward the second end of the communication, which packets contain information resulting from the application layer processing.

### BRIEF DESCRIPTION OF THE FIGURE

FIG. 1 shows a diagram of a standard configuration of a client-server connection using a network in which an agent has been inserted to perform an encryption and decryption function according to an SSL family of security protocols;

FIG. 2 shows a schematic diagram of conventional information flow from a sender to a receiver where an agent has been inserted to perform an encryption and decryption function according to an SSL family of security protocols;

FIG. 3 shows a schematic diagram of information flow from a sender to a receiver in accordance with an embodiment of the present invention;

FIG. 4 shows a block diagram of an embodiment of an inventive, non-proxy-mode SSL system;

FIG. 5 shows a block diagram illustrating how an embodiment of the present invention changes seq and ack for messages transmitted between a client and a server;

FIG. 6 shows, in pictorial form, session messages that are transferred between a client, an inventive, non-proxy-mode SSL system, and a server;

FIG. 7 shows a flowchart of operation for the embodiment shown in FIG. 4; and

FIG. 8 shows a detailed portion of the flowchart shown in FIG. 7.

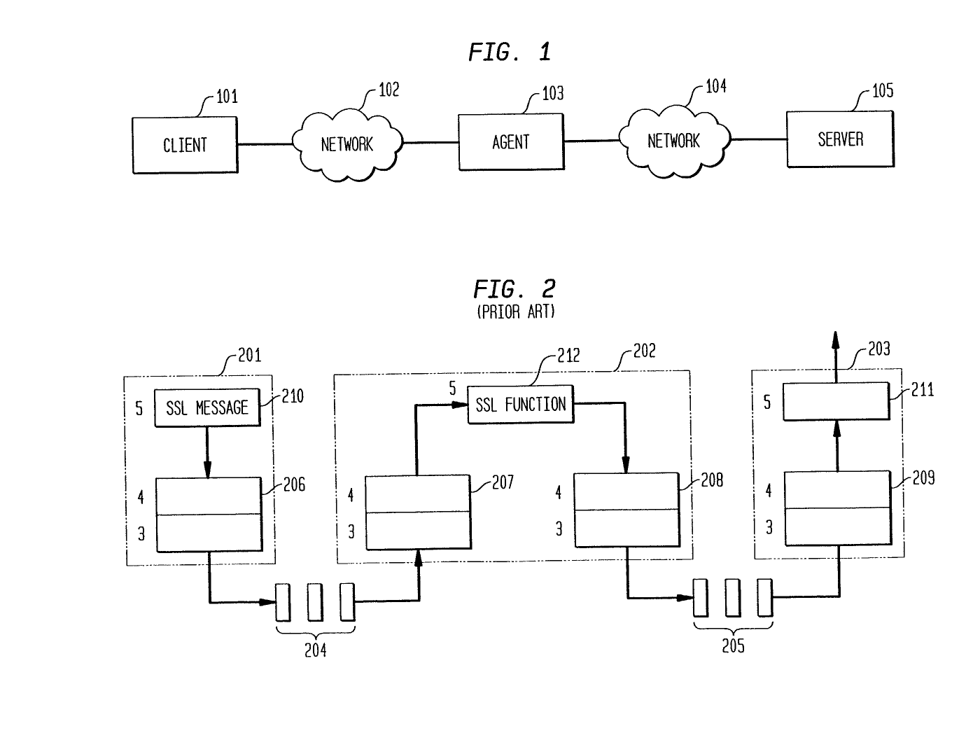

### DETAILED DESCRIPTION

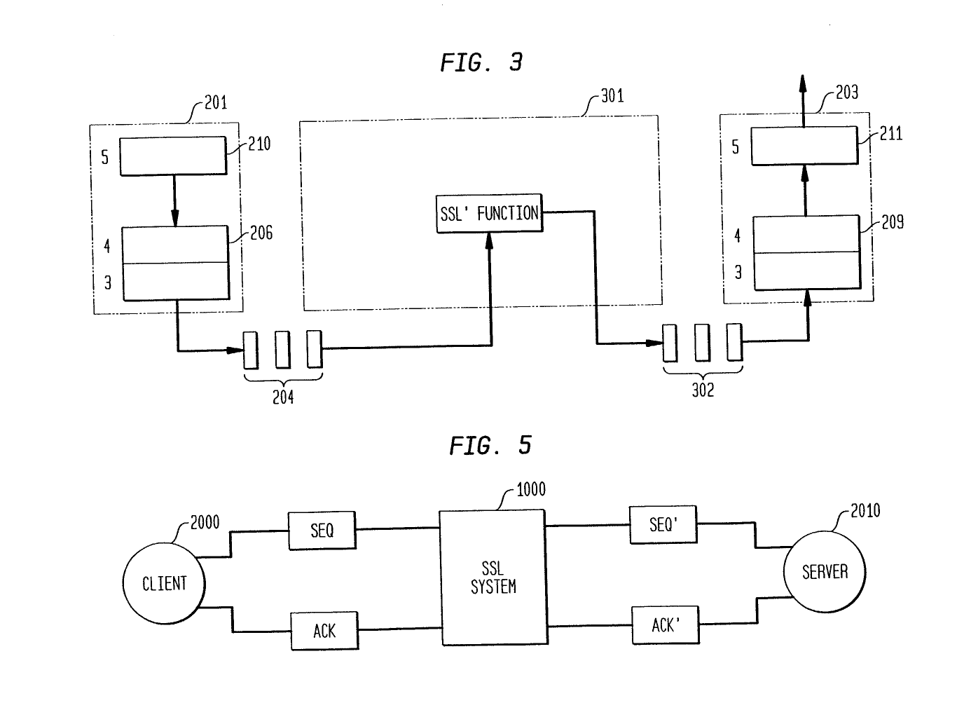

FIG. 3 shows a schematic diagram of information flow from sender 201 to receiver 203 in accordance with one embodiment of the present invention. Note that sender 201 may be either a client or a server in a network relationship. As shown in FIG. 3, general application message handler 210 (for example, an SSL message handler) in sender 201 forms a general application message (for example, an SSL message), and sends the general application message (for example, an SSL message) to TCP/IP stack routine 206 of sender 201 (stack routine 206 is shown schematically to comprise a layer 4 queue structure and a layer 3 queue structure). TCP/IP stack routine 206 transmits layer 3 packets 204 out of a network interface (typically, an Ethernet adapter card) at sender 201 onto a network, for example and without limitation a public network such as the Internet. Layer 3 packets 204 are received by a network interface (typically, an Ethernet adapter card) at inventive, non-proxy agent 301. In accordance with this embodiment of the present invention, layer 3 packets 204 arriving at the network interface (not shown) of agent 301 are processed individually to enable general application specific transmission (for example and without limitation, they are processed to perform encryption/decryption), and sent out onto a network, for example and without limitation, a private network, as layer 3 packets 302. As will be described in detail below, layer 3 packets 302 are not necessarily identical to layer 3 packets 205 described above in the Background of the Invention in conjunction with FIG. 2. As was discussed above, in the Background of the Invention, since general application functionality (for example, an SSL functionality) is not sensitive to the operation of layers 4 and below, the fact that layer 3 packets 302 have different characteristics than layer 3 packets 205 does not impact general application messages (for example, SSL messages). Layer 3 packets 302 are received by a network interface at receiver 203, and they are assembled and interpreted by TCP/IP stack 209 running on receiver 203 (stack routine 209 is shown schematically to comprise a layer 4 queue structure and a layer 3 queue structure). TCP/IP stack routine 209 combines layer 3 packets 302 and resulting TCP segments to form a complete general application message 211 (for example, an SSL message), which general application message 211 (for example, an SSL message) is identical to general application message 211 (for example, an SSL message) obtained by the prior art implementation described in the Background of the Invention in conjunction with FIG. 2.

In accordance with this embodiment of the present invention, inventive, non-proxy agent 301 performs the following functions: (a) passes TCP connection establishment messages from sender to receiver and vice versa (hence the designation non-proxy agent), but records some of the exchanged information to provide a “quasi-three-way” handshake; (b) intercepts general application session messages (for example, an SSL session message), and responds to the sender to: (i) set up a general application session (for example, an SSL session) between the sender and inventive, non-proxy agent 301 by handling any general application handshake (for example, an SSL handshake) and (ii) terminate a general application session (for example, an SSL session) between the sender and inventive, non-proxy agent 301 in response to general application session (for example, SSL session) termination messages; (c) intercepts intermediate data transfers relating to general application messages (for example, bulk data transfer SSL messages from the sender to the receiver) and performs general application data processing (for example, decrypts/encrypts) on messages (from client/server, respectively); and (d) passes TCP connection termination messages from sender to receiver and vice versa.

Although the following will be described mainly in view of a non-proxy agent that deals with SSL processing (for example, as will be explained in detail below, by using “packet markers,” the non-proxy agent is able to perform SSL processing for out-of-order packets, but does not need to perform TCP processing for out-of-order packets), it should be clear that embodiments of the present invention are not limited thereto. In fact other embodiments exist wherein the application processing includes functions such as, for example and without limitation, verification that XML messages are valid; translations of data from a first form or format to another form or format; content inspection and/or analysis; and so forth. This inventive technique of fusing any application layer with a transport layer, and minimizing transport layer processing can be used for any application that runs above the transport layer. In other words, by processing traffic as a non-proxy agent, the agent eliminates TCP overhead, and this technique can be applied to any application layer protocol, and can be applied to any network processing appliance.

In order to bypass a transport layer in accordance with one or more embodiments of the present invention, application processing is performed at a lower layer. In other words, the transport layer and the application layer (and any other lower layers) are merged as one layer. This means that instead of performing two passes over a data segment, once by a TCP layer and once by an application layer, in accordance with one embodiment of the present invention, just one pass is performed over the data. Such embodiments thereby provide an application of a well-known technique in compiler processing to network processing.

It should be noted that in order to be a complete non-proxy, application processing should have an ability to buffer data at a network processor without violating the transport layer, for example, the TCP protocol. One instance of this, as will set forth in detail below, entails processing long SSL messages, i.e., messages where an encrypted SSL message is longer than a TCP packet length. As will be set forth in detail below, several techniques are used to maintain consistency of TCP states between a client and a server when the network processor is buffering data.

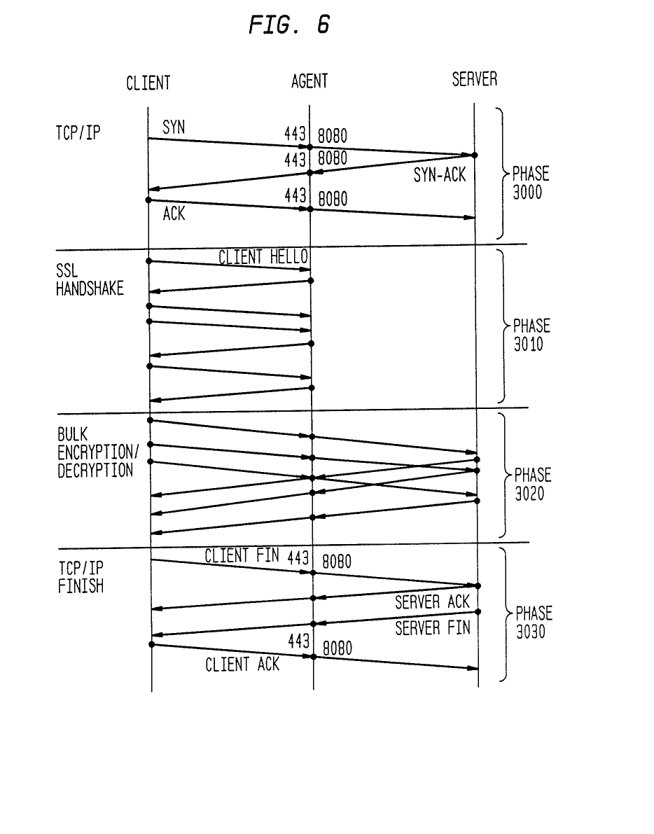

FIG. 6 shows, in pictorial form, session messages that are transferred among a client, an inventive, non-proxy-mode, general application system, (for example, an SSL system), and a server. As one can readily appreciate from this, TCP/IP connection establishment messages (which messages will be described in detail below) are shown to flow between the client and the server through the inventive, non-proxy-mode agent (in a manner that will be described in detail below) during phase 3000. General application handshake messages (for example, SSL handshake messages) (which messages will be described in detail below) are shown to flow between the client and the inventive, non-proxy-mode agent (in a manner that will be described in detail below) during phase 3010. General application bulk processing messages (for example, encryption/decryption SSL processing messages) are shown to flow between the server and the client and between the client and the server, respectively (which general application bulk processing messages will be described in detail below) through the inventive, non-proxy-mode agent (in a manner that will be described in detail below) during phase 3020. Lastly, TCP/IP connection termination messages (which messages will be described in detail below) are shown to flow between the client and the server through the inventive, non-proxy-mode agent (in a manner that will be described in detail below) during phase 3030.

In accordance with this embodiment of the present invention, in essence, inventive, non-proxy agent 301 receives all incoming network traffic, and intercepts general application session-related traffic (for example, SSL session-related traffic). In addition, in accordance with this embodiment, inventive, non-proxy agent 301 implements a general application protocol (for example, a higher-level security protocol such as, without limitation, an SSL family security protocol) on a packet-by-packet basis (for example and without limitation, on a layer 3 packet by layer 3 packet basis). In the prior art, security protocols are typically associated with lower-layer security protocols such as IPSec (a layer 3 security protocol), or PPTP (a layer 2 security protocol). Advantageously, as will be described in detail below, a key to the speed and memory-efficiency of embodiments of the present invention in handling general applications transactions (for example, SSL application transactions) is that such embodiments do not terminate a TCP connection from either a client or a server as is believed to be the case for prior art “proxy” mode firewalls such as Intel's iPivot box, and so forth, Instead, as was described above in conjunction with FIG. 3, inventive, non-proxy agent can act “like a router,” and process each layer 3 (for example, IP layer) packet independently. Advantageously, embodiments of the present invention provide order-of-magnitude improvements in processing speed and memory requirements over those available in the prior art.

For the sake of understanding embodiments of the present invention, the following terminology will be used: incoming traffic refers to traffic sent from a client to a server (i.e., an “inbound” packet refers to a packet sent from a client to a server) and outgoing traffic refers to traffic from the server to the client (i.e., an “outbound” packet refers to a packet sent from the server to the client).

Before discussing specific details of an embodiment of the present invention, the following overview will be given to enable one to better understand how such an embodiment operates.

It is helpful to understand that, in a typical communication, inbound traffic is light, i.e., just GET and POST requests from a browser (for example, “give me my checking account history”), and outbound traffic is heavy, i.e., lots of actual HTML page data.

Pre-Filter

Frames are input to network interfaces at an embodiment of the inventive, non-proxy agent where a frame comprises, for example and without limitation: (a) an Ethernet header; (b) an IP header; (c) a TCP header; (d) a general application header (for example, an SSL header); (e) data; and (f) an Ethernet trailer. In accordance with this embodiment of the present invention, the inventive, non-proxy agent examines frames to “pre-filter” them. For example, this “pre-filter” step entails carrying out functions such as, for example, and without limitation: (a) evaluating the checksum of the link (for example, Ethernet) layer, the IP layer and the TCP layer; (b) looking for logical errors (such as, for example, inconsistent frame length, IP length, and TCP header length); (c) determining whether a frame is a non-IP frame; (d) determining whether the frame is a non-general application frame (for example, a non-SSL frame); and (e) determining whether a frame corresponds to a TCP frame. All of these individual “pre-filter” functions can be carried out using any one of a number of methods that are well known to those of ordinary skill in the art.

In accordance with this embodiment of the present invention, if the frame (i.e., the link layer) contains, for example and without limitation, a logical error (for example, an incomplete packet as determined by an analysis of the link layer header) or an improper checksum, the frame may, for example and without limitation, be dropped (i.e., no further processing is carried out, and the frame is not forwarded). If the frame does not contain an IP packet, or a TCP segment, or does not pertain to the general application (for example, SSL), it is forwarded to the receiver without any further action being taken.

TCP Connection Establishment and Termination

In general, as set forth in the following quote from page 231 of the book entitled “TCP/IP Illustrated, Volume 1—The Protocols” by W. Richard Stevens, published by Addison-Wesley, 1994:

1. The requesting end (normally called the client) sends a SYN segment specifying the port number of the server that the client wants to connect to, and the client's initial sequence number (ISN, 1415531521 in this example). This is segment 1.

2. The server responds with its own SYN segment containing the server's initial sequence number (segment 2). The server also acknowledges the client's SYN by ACKing the client's ISN plus one. A SYN consumes one sequence number.

3. The client must acknowledge this SYN from the server by ACKing the server's ISN plus one (segment 3).

These three segments complete the connection establishment. This is often called the three-way handshake.

In accordance with one embodiment of the present invention, if a frame relates to TCP connection establishment, the inventive, non-proxy agent will forward the frame to the receiver, but will also record certain TCP information relating to the TCP connection and its establishment.

Each TCP segment contains a 16-bit source port number and a 16-bit destination port number to identify the sending and receiving applications. These two values, along with a 32-bit source IP address and a 32-bit destination IP address in the IP header, uniquely identify each TCP connection.

Thus, for a SYN TCP message (which TCP message is typically sent from the client to the server, and which TCP message signals the start of the establishment of a TCP connection), the recorded TCP information in general includes, for example and without limitation, a 16-bit source port number (from the TCP header), a 16-bit destination port number (from the TCP header), a 32-bit source IP address (from the IP header), a 32-bit destination IP address (from the IP header), and an initial seq number chosen by the host (for example, the client) for the connection, for example, X. As is well known to those of ordinary skill in the art, “seq” refers to a 32-bit TCP sequence number in the TCP header of a TCP segment, and “ack” refers to a 32-bit acknowledgment number in the TCP header of a TCP segment. Seq denotes the byte number in the TCP message that corresponds to the first byte in the data portion of the transmitted segment), and ack denotes the byte number in the TCP message that the recipient expects to receive as the first byte of the data portion of the next TCP segment.

In response to the SYN TCP connection establishment message from the client, the server will respond with a SYN-ACK TCP message. In this case, the inventive, non-proxy agent will also forward the frame to the client, but will also record certain TCP information for the SYN-ACK TCP message (which TCP message is typically sent from the server to the client), such recorded TCP information includes, for example and without limitation, an initial seq number chosen by the server for the connection, for example, Y, and an ack number X+1. The 16-bit source port number (from the TCP header), the 16-bit destination port number (from the TCP header), the 32-bit source IP address (from the IP header), and the 32-bit destination IP address (from the IP header) of the SYN-ACK TCP message should agree with that stored for the corresponding SYN TCP message because those parameters uniquely identify the TCP connection.

In response to the SYN-ACK TCP message, the client will respond with an ACK message. In this case, the inventive, non-proxy agent will forward the frame to the server, but will also record certain TCP information for the ACK TCP message, such TCP information includes, for example and without limitation, an ack number Y+1.

In general, as set forth in the following quote from page 233 of the book entitled “TCP/IP Illustrated, Volume 1—The Protocols” by W. Richard Stevens, published by Addison-Wesley, 1994:

While it takes three segments to establish a connection, it takes four to terminate a connection. This is caused by TCP's half-close. Since a TCP connection is full-duplex . . . , each direction must be shut down independently. The rule is that either end can send a FIN when it is done sending data. When a TCP receives a FIN, it must notify the application that the other end has terminated that direction of data flow. The sending of a FIN is normally the result of the application issuing a close.

The receipt of a FIN only means there will be no more data flowing in that direction. A TCP can still send data after receiving a FIN. . . .

We say that the end that first issues the close (e.g., sends the first FIN) performs the active close and the other end (that receives this FIN) performs the passive close. . . .

When the server receives the FIN, it sends back an ACK of the received sequence number plus one (segment 5). A FIN consumes a sequence number, just like a SYN. At this point the server's TCP also delivers an end-of-file to the application (the discard server). The server then closes its connection, causing its TCP to send a FIN (segment 6), which the client TCP must ACK by incrementing the received sequence number by one (segment 7).

In accordance with one embodiment of the present invention, if a frame relates to TCP connection termination, the inventive, non-proxy agent will forward the frame, for example, to the server, but will also record certain TCP information for a FIN TCP message which signals the end of a TCP connection. Thus, for a FIN TCP message, the recorded TCP information includes, for example and without limitation, the 16-bit source port number (from the TCP header), the 16-bit destination port number (from the TCP header), the 32-bit source IP address (from the IP header), and the 32-bit destination IP address (from the IP header) so that the inventive, non-proxy agent can mark the end of a particular connection. In response to the FIN TCP message, the server will respond with an ACK TCP message. In this case, the inventive, non-proxy agent will forward the frame to the client, but will terminate its tracking of the TCP connection from the client to the server. Similar messages will terminate the TCP connection from the server to the client.

Note that, in accordance with one embodiment of the present invention, all TCP connection establishment and termination messages are sent through the inventive, non-proxy agent, and that the TCP connection has been set up directly between the client and the server. However, in order to implement the functions that are described in detail below, the inventive, non-proxy agent maintains a subset of the TCP connection information to define an internal “TCP Connection State.” An embodiment of a TCP Connection State and the manner of its use in accordance with an embodiment of the present invention will be described in detail below.

There are many methods that are well known to those of ordinary skill in the art for recognizing the various well known TCP connection establishment and termination messages so that they can be processed in the manner set forth above.

General Application (For Example, SSL) Handshake

In accordance with this embodiment of the present invention, if a frame relates to the general application handshake protocol (for example, the SSL handshake protocol), the inventive, non-proxy agent will respond to all such messages itself, and not pass such messages through to the server. As an example of dealing with a general application handshake, we will discuss dealing with the SSL handshake protocol). As is well known to those of ordinary skill in the art, SSL comprises four (4) different component protocols: (a) change cipher; (b) alert; (c) handshake; and (d) application data. The main operations of SSL are: (a) to establish a secure session (this is accomplished by the handshake and change cipher protocols); (b) to transfer encrypted data (this is accomplished by the application data protocol); and (c) to handle errors (this is accomplished by the alert protocol). See a book by Stephen Thomas entitled “SSL and TLS Essentials, Securing the Web,” published by John Wiley & Sons, Inc., 2000.

The SSL handshake protocol comprises a series of phases that are well known to those of ordinary skill in the art, but for purposes of understanding embodiments of the present invention, it can be typically broken down into four (4) phases: (phase 1) a “client hello” message; (phase 2) a “server hello” message, a “server certificate” message and a “server hello done” message; (phase 3) a “client key exchange” message, a “change cipher spec” message, and a “finished” message; and (phase 4) a “change cipher spec” message and a “finished” message. In phase 1, the client sends some random numbers and a set of ciphers it can handle. In phase 2, the server decides on a particular cipher, and sends the client some random numbers and a certificate that contains the server's public key, In phase 3, the client verifies the server's authenticity and sends back some encrypted information to set the keys, and some encrypted authentication information about the whole session. After this, the client sends all subsequent messages encrypted according to the agreed-upon cipher parameters. Lastly, in phase 4, the server decrypts the information sent by the client and authenticates the session. The server sends back to the client some encrypted information to authenticate the session, and from this point on, all subsequent messages are encrypted according to the agreed-upon cipher parameters. The most time consuming component of this exchange for the server is the decryption of messages sent by the client since it is encrypted with the server's public key. For example, for RSA this involves thousands of arithmetic operations on very wide numbers. In addition to encryption, SSL enables an option of including message signatures (for SSL versions 3.0 and 3.1, message signatures are always included). Operations on the alternative signing algorithms have similar data dependencies as encryption, i.e., the packets have to be in order.

As is well known to those of ordinary skill in the art, SSL supports algorithms for a message authentication code (“MAC”). To calculate (or verify) the MAC, a system uses a two-stage hash very similar to hash computations in the handshake messages. It starts with a special value known as the MAC secret, followed by padding, a 64-bit sequence number, a 16-bit value with the length of the content, and, finally, by the content itself. For the second stage, the system uses the MAC write secret, padding, and the output of the intermediate hash. This result is the MAC value that appears in SSL messages. Two special values included in this calculation are the MAC write secret and the sequence number. The sequence number is a count of the number of messages the parties have exchanged. Its value is set to 0 with each ChangeCipherSpec message, and it is incremented once for each subsequent SSL Record Layer message in the session.

The SSL specification also recognizes that some of the information (in particular, the key material) will be different for each direction of communication. In other words, one set of keys will secure data the client sends to the server, and a different set of keys will secure data the server sends to the client. For any given system, whether it is a client or a server, SSL defines a write state and a read state. The write state defines the security information for data the system sends, and the read state defines the security information for data that the system receives. Thus, each state has a encryption algorithm, a write state encryption key, a read state encryption key, a message integrity algorithm (abbreviated “MAC” for Message Authentication Code) such as, for example and without limitation, Secure Hash Algorithm (“SHA”) or RSA's Message Digest 5 (“MD5”), a write state MAC key, and a read state MAC key.

Whenever a new client tries to connect to a secure server, the client and server must execute the SSL handshake protocol to agree on a cipher suite and session keys to be used for the secure data transfer as well as to authenticate each other. For a server, this SSL handshake typically involves two reads and two writes. In accordance with this embodiment of the present invention, all of the above is performed by the inventive, non-proxy agent instead of the server. During the SSL handshake, among other things, the inventive, non-proxy agent saves SSL information to define an “SSL Connection State.” An embodiment of an SSL Connection State and the manner of its use in accordance with an embodiment of the present invention will be described in detail below.

As is well known to those of ordinary skill in the art, SSL supports stream ciphers and block ciphers. As is also well known, block ciphers are typically sixty-four (64) bits wide (this is the case for DES and 3DES, which are the only block ciphers used in SSL versions 3.0 and 3.1), and are used in a cipher block chaining (“CBC”) mode. In particular, this means that encoding/decoding a block of data (for example, each cipher specifies a standard block size) requires use of encoding/decoding results from immediately previous block(s). Although a stream cipher does not have such a dependency on the operation for a previous block, there is a dependency on the key. This requires that the inventive, non-proxy agent save this type of information as part of its “SSL Connection State.” As is well known to those of ordinary skill in the art, block ciphers usually require an initialization vector of dummy data with which to begin the encryption process, i.e., the initialization vector primes the algorithm, and is determined as part of the SSL handshake in a manner that is well known to those of ordinary skill in the art.

There are many methods that are well known to those of ordinary skill in the art for recognizing the various well known SSL session messages so that they can be processed in the manner set forth above.

The following describes one embodiment of SSL handshake processing for the openssl implementation of SSL Version 3.0 handshake. In a first “server_read” step, the agent receives a client_hello message from the client that lists a set of proposed cipher suites to be used during the session and a 32 Byte random number that will be referred to below as the client random. In a first “server_write” step, the agent sends a server_hello message selecting one of the proposed cipher suites and a 32 Byte random number that will be referred to below as the server random. In a second “server_write” step (optional), the agent sends a server_certificate message authenticating itself. In a third “server_write” step, the agent sends a message containing its signed public key (the client will use this to encrypt its session key); the public key is hashed and then signed using the agent's digital signature. This message is not required if the server_certificate has its RSA public key for encryption (a common case). This message is required only if the following conditions are true: (a) Diffie Hellman or Fortezza is used for key-exchange; (b) the server certificate is signed using DSS; (c) RSA is used for key exchange, but the server certificate does not have the RSA public key; (d) the agent is exporting the key exchange keys, and the keys specified in the server certificate enable strong RSA encryption; and (e) agent authentication is not required. In a fourth “server_write” step (optional), the agent sends a message requesting the client to authenticate itself. In a fifth “server_write” step, the agent sends a server_done message indicating that it is done.

In a first “server_read” step, the agent receives the client certificate, if requested and verifies it. In a second “server_read” step, the agent receives the client session key encrypted with the agent's public key. The agent decrypts the key and computes the master secret and the key material. In a third “server_read” step, the agent receives the finished message encrypted with the session key. The agent decrypts the messages and verifies that it is a hash of all the messages sent and received thusfar.

In a first “server_write” step, the agent sends a change_cipher_spec message indicating that any message afterwards will be encrypted using the agreed upon session key. In a second “server write” step, the agent sends a finished message with a hash of all messages received thusfar, encrypted with the session key and authenticated.

For a general application handshake, although the details of the protocol may differ from those of the SSL handshake, one would create the General Application Connection State in manner analogous to the way (as described above) in which the SSL Connection state was created.

TCP Packet Handling

In accordance with this embodiment of the present invention, to properly enable a TCP connection between a client and a server, whenever traffic passes through the inventive, non-proxy agent, the inventive, non-proxy agent must modify TCP sequence numbers, in both directions. This must occur since, as was described above, the inventive, non-proxy agent, among other things, intercepts general application handshake messages (for example, SSL handshake messages) (and does not pass them through to the server), and does processing of data in general application session messages (for example, decrypts/encrypts data in SSL session messages), thereby changing the amount of data contained in TCP packets. To understand how this occurs, assume, for the sake of illustration, that “A” is a sender (“A” could be a client or a server), and further assume, for the sake of illustration, that “B” is a recipient. In accordance with normal TCP handling, “B” will send an ack every now and then according to the rules of its TCP/IP protocol, which ack specifies the next byte of the TCP message “B” is ready to receive. As was discussed above, depending on the size of a TCP window, “A” may send multiple packets without having received any acks. As is well known to those of ordinary skill in the art, this is done to enable data to be transmitted on a steady basis. However, if at some point in the future when a timer at “A” expires since “A” has not received an ack, “A” will resend a packet whose payload starts from the byte in the TCP message corresponding to the last ack “A” received.

Further assume that the inventive, non-proxy agent is situated in the middle of the transmission between the client and the server. As each packet in the TCP connection goes by, the inventive, non-proxy agent adds/subtracts some number of bytes; due to padding, this number is not a constant. Whenever an ack goes back to the sender from the recipient, the inventive, non-proxy agent has to determine an appropriate offset for the ack in the TCP message so that the sender will send data starting from the appropriate position in the message. To further understand this, assume that the inventive, non-proxy agent received a packet from the sender that contained data corresponding to bytes 15 to 51 in the message (seq would equal 15 and the message length would equal 37 bytes), and that the inventive, non-proxy agent only sent bytes 15 to 41 from the message to the receiver as bytes 7 to 33 (for example, because inventive, non-proxy agent threw away 10 bytes). In such a case, the inventive, non-proxy agent would change the message length to 27. In response, the recipient would sent an ack which equals 34, i.e., the next byte it expected to receive. However, the sender has already sent byte 51. As a result, the inventive, non-proxy agent needs to adjust the ack to equal 52.

In addition, as described above, in order to enable a general application session (for example, an SSL session), the inventive, non-proxy agent must be mindful of the order of TCP packets, since general application may require (for example, encryption requires) an ordered stream (for example, as described above, this is required by the CBC mode in SSL processing). The manner in which this is handled will be described in detail below.

Routing

In accordance with this embodiment of the present invention, if a frame relates to application data that is to be processed (for example, encrypted/decrypted) according to parameters established during the general application (for example, SSL handshake), and then forwarded to the server/client, respectively, the inventive, non-proxy agent will perform the appropriate general application processing (for example, encryption/decryption), and forward the resulting information. As one can readily appreciate, traffic that the inventive, non-proxy agent processed in one way (for example, decrypted) on the way from the client to the server might be processed using similar parameters (for example, must be encrypted using the same cipher suite) on the way from the server to the client. In essence, this means that both traffic directions might have to (for example, must) go through the inventive, non-proxy agent. This can occur in accordance with any one of a number of methods. For example, in one configuration, an embodiment of the inventive, non-proxy agent is placed in front of a load balancer (a load balancer is an apparatus that is well known to those of ordinary skill in the art) which is, itself, in front of a server to which secure transactions are to be directed. As another example, the inventive, non-proxy agent spoofs the Internet frame address which appears in the frame header in a manner that is well known to those of ordinary skill in the art to indicate the source of a frame to be the inventive, non-proxy agent.

Non-Proxy Agent

The following describes one embodiment of the present invention which is an inventive, non-proxy agent.

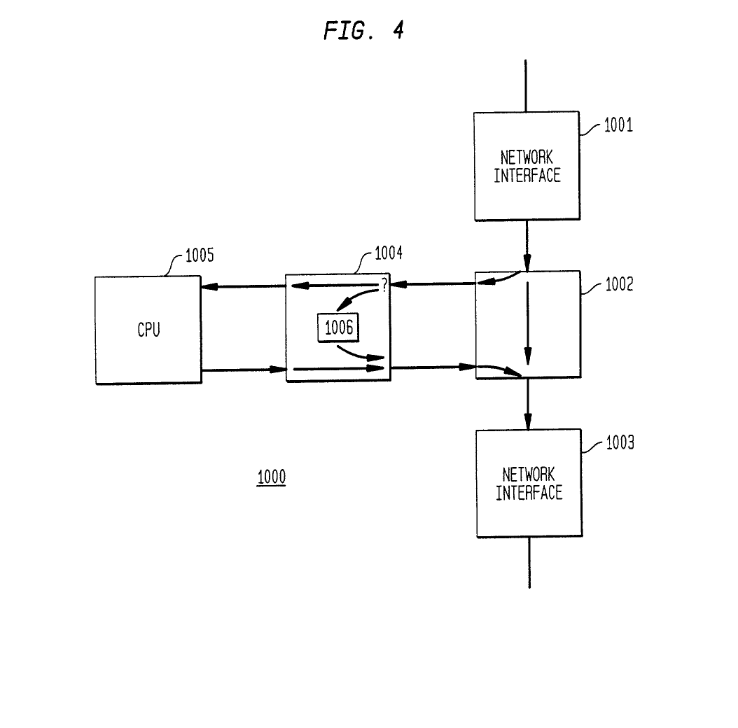

FIG. 4 shows a block diagram of an embodiment of an inventive, non-proxy, general application system (for example, SSL system). As shown in FIG. 4, network interfaces 1001 and 1003 of inventive, non-proxy, general application system 1000 connect to client and server networks, respectively. Many methods are well known to those of ordinary skill in the art for fabricating network interfaces 1001 and 1003. In accordance with this embodiment of the present invention, traffic flows bi-directionally between a multiplicity of clients and servers, but for clarity and ease of understanding this embodiment of the present invention, inbound packet direction for a connection between a single client and server is shown only. As shown in FIG. 4, link layer (layer 2) traffic comes over a network, for example and without limitation, a public network such as the Internet, into network interface 1001, and is passed to unit 1002. As should readily be appreciated by those of ordinary skill in the art, network interfaces 1001 and 1003 handle layers 1 and 2 of a network protocol. In accordance with this embodiment of the present invention, unit 1002 is embodied as a hardware logic unit that itself is implemented in a field-programmable gate array (“FPGA”), although other implementations are possible including, for example and without limitation, a standard network processor unit (NPU), a central processing unit (CPU), an application-specific integrated circuit (“ASIC”), and so forth.

In accordance with this embodiment of the present invention, unit 1002 performs a pre-filter function. In particular, it tags an incoming frame with, for example, physical identifiers such as, input port number (used to route traffic), and checks the incoming frame: (a) to determine whether the checksum is proper or whether the frame is incomplete (if the checksum is improper, or the frame is incomplete, the input is dropped); and (b) to determine whether the frame is a non-IP or a non-general application frame (for example, a non-SSL frame) (if it is a non-IP or non-general application frame, it is sent to a network interface for forwarding to the receiver). If the incoming frame passes the pre-filter function performed by unit 1002, data contained therein is forwarded to unit 1004 for further filtering. This data comprises the TCP segment and will be referred to as a TCP packet.

In accordance with this embodiment of the present invention, unit 1004 determines whether the TCP packet corresponds to Bulk data transfer (i.e., data transfer between the client and server after the TCP connection and the general application session (for example, the SSL session) have been established). If unit 1004 determines that a TCP packet relates to Bulk data transfer for an existing TCP connection and an existing general application session (for example, SSL session), the TCP packet is sent to bulk encryption/decryption unit 1006 for processing. If not, because, for example, the TCP packet relates to TCP connection establishment (between the client and server), TCP connection termination (for either the client or the server), general application handshake (for example, SSL handshake) (between the client and inventive, non-proxy, general application system 1000), or general application session termination (for example, SSL session termination), it is sent to CPU 1005 for processing. In accordance with this embodiment of the present invention, unit 1004 is embodied as a hardware logic unit that itself is implemented in an FPGA, although other implementations are possible including, for example, and without limitation, a standard network processor unit (NPU), a central processing unit (CPU), or an application-specific integrated circuit (ASIC).

Unit 1004 makes the above-described determination, for example, by referring to the existence of an entry in a connection table, implemented in one embodiment as a “Client Hash Table” for an established TCP connection and an established general application session (for example an SSL session) that relates to the TCP packet. In accordance with one embodiment of the present invention, the Client Hash Table is stored (storage may be any one of a number of storage devices that are well known to those of ordinary skill in the art such as a memory device) in storage having shared access by unit 1004, unit 1006, and CPU 1005, which Client Hash Table is created in a manner that will be described in detail below. In accordance with one embodiment of the present invention, a retrieval key for the Client Hash Table is a combination of the client IP address (from the IP header) and client TCP port number (from the TCP header). In accordance with this embodiment of the present invention, the entry in the Client Hash Table is made by CPU 1005 after the general application handshake (for example, the SSL handshake) has been completed, and the entry comprises a pointer to an entry in a “Buff TCP Control Block.” The Buff TCP Control Block comprises a TCP Connection State (see Table I which shows one embodiment of a TCP Connection State) and a general application Connection State (for example, an SSL Connection State) (see Table II which shows one embodiment of an SSL Connection State), which entry in the Buff TCP Control Block is also made by CPU 1005 after the general application handshake (for example, the SSL handshake) has been completed. The Buff TCP Control Block is stored in a storage device having shared access by unit 1006 and CPU 1005 (the storage device may be any one of a number of types of storage devices that are well known to those of ordinary skill in the art such as a memory device).

CPU 1005 is a standard CPU running software that can handle TCP connection establishment, TCP connection termination, general application handshake (for example, SSL handshake), general application session termination (for example, SSL session termination), and bulk data exchange. In one embodiment of the present invention, CPU 1005 only handles “corner cases” for bulk data exchange.

TCP Connection State

In accordance with one embodiment of the present invention, CPU 1005 processes TCP packets to handle TCP connection establishment and termination. Each TCP segment contains a 16-bit source port number and a 16-bit destination port number to identify the sending and receiving applications, and as is well known to those of ordinary skill in the art, these two values, along with a 32-bit source IP address and a 32-bit destination IP address in the IP header, uniquely identify each TCP connection.

In accordance with one embodiment of the present invention, whenever a client sends a secure message to a server, it accesses a predetermined destination port number (for example and without limitation, 443, or some other predetermined number). In this embodiment of the present invention, this fact may be used to identify general application messages (for example, SSL messages). However, since general purpose system 1000 processes (for example, SSL system 1000 decrypts) messages intended for the server, it may change the destination port number whenever the processed (for example, decrypted) counterparts are forwarded to the server to a destination port number that has not been earmarked to receive processed (for example, encrypted) messages (for example and without limitation, 8080, or some other predetermined number). Likewise, whenever the server sends messages to the client, it does not send them to a port that has been earmarked to receive processed (for example, encrypted) messages because the server transmits its messages in plaintext to general application system 1000. In one specific embodiment, the server sends its messages to port 8080. However, since general application system 1000 processes (for example, encrypts) messages intended for the client, it changes the destination port number whenever the processed (for example, encrypted) counterparts are forwarded to the client to a port number that is earmarked to receive processed (for example, encrypted messages) (for example and without limitation, 443, or some other predetermined number). As a result, for such an embodiment, the TCP connection is identified by the 32-bit source IP address, and the 16-bit source port number.

In accordance with one embodiment of the present invention, CPU 1005 places an entry into a “Client Hash Table” in a storage device having shared access with unit 1004 and unit 1006 (the storage device may be any one of a number of types of storage devices that are well known to those of ordinary skill in the art such as a memory device). Each entry is reached by processing a retrieval algorithm using the 32-bit source IP address and the 16-bit source port number of the TCP connection as a retrieval key. In accordance with one embodiment of the present invention, this algorithm is a hash algorithm. The entry in the Client Hash Table is a pointer to a Buff TCP Control Block that includes a TCP Connection State and a general application Connection State (for example, an SSL Connection State). The Client Hash Table is set up by CPU 1005 after the TCP connection has been established, and after the general application session (for example, the SSL session) has been established. The Buff TCP Control Block is initially created by CPU 1005, and is stored in a storage device having shared access with unit 1006 (the storage device may be any one of a number of types of storage devices that are well known to those of ordinary skill in the art such as a memory device) for use in processing bulk data in the manner described in detail below.

Table I shows information stored in a TCP Connection State for one embodiment of the present invention. As was discussed above, in accordance with this embodiment of the present invention, general application system 1000 is a non-proxy agent and, as a result, there is no need to store all of the information associated with a TCP connection. Thus, for each TCP connection, several variables are saved for each direction of information flow, along with a pointer to an associated general application Connection State (for example, an associated SSL Connection State; the variables will be described in detail below.

After the TCP Connection State and the general application Connection State (for example, the SSL Connection State) have been set up (see below), and an entry has been created in the Client Hash Table, TCP packets are filtered in unit 1004. Unit 1004 does this by searching the Client Hash Table for an entry corresponding to the client IP address and the client port to determine whether a TCP connection and a general application session (for example, an SSL session) have been established for the TCP packet. If so, the TCP packet is sent to bulk encryption/decryption unit 1006 directly for processing—with no interaction by CPU 1005. Advantageously, this enhances the performance of general application system 1000, because the data rate of TCP packets entering general application system 1000 is typically far greater than the capacity of CPU 1005 to handle each TCP packet.

General Application Connection State (For Example, SSL Connection State)

In accordance with this embodiment of the present invention, a general application session (for example, an SSL session) is established for every client that requests a general application service (for example, a secure service) through a general application handshake (for example, an SSL handshake). In accordance with this embodiment of the present invention, and for ease of understanding the present invention, general application system 1000 maintains a general application Connection State (for example, an SSL Connection State) that is independent of the TCP Connection State.

As was described above, and as is well known to those of ordinary skill in the art, a typical general application session (for example, an SSL session) includes: (a) a general application handshake (for example, an SSL handshake—all of whose messages are described in detail in a book entitled “SSL and TLS Essentials, Securing the Web” by Steven Thomas, Published by John Wiley & Sons, Inc., 2000) to establish the general application session (for example, the SSL session); (b) then, a sequence of TCP packets of application data, and (c) then, a general application Finish (for example, an SSL Finish) and possibly other messages to end the session. In accordance with this embodiment of the present invention, CPU 1005 handles the general application handshake and session termination (for example, the SSL handshake and session termination), and then turns over the rest of the task of handling the general application session bulk data transfer (for example, the SSL session bulk data transfer) to unit 1006.

In accordance with one embodiment of the present invention, general application system 1000 precludes the server from receiving data that has bad preliminary data (for example, a bad signature). To do this, whenever CPU 1005 detects bad preliminary data (for example, a bad signature) during general application handshake (for example, SSL handshake), it sends a general application alert message (for example, an SSL alert message) to the client to cause the client to close the connection. The closure will not be seen by the server, and the transaction will fail.

CPU 1005 creates a general application Connection State (for example, an SSL Connection State) and stores it in Buff TCP Control Block, storing a pointer to the general application Connection State (for example, the SSL Connection State) in the associated TCP Connection State. The general application Connection State (for example, the SSL Connection State) is stored in a storage device that is shared with unit 1006 (the storage device may be any one of a number of types of storage devices that are well known to those of ordinary skill in the art such as a memory device). Further, whenever, the general application handshake (for example, the SSL handshake) is complete, the general application Connection State (for example, the SSL Connection State) is associated with the TCP Connection State, and an entry is made in the Client Hash Table with a pointer to the TCP Connection State.

An example of a general application Connection State, specifically, an SSL Connection State for one embodiment of the present invention is shown in Table II, some of the entries in SSL Connection State for this embodiment of the present invention include: (a) Cipher Code; (b) read state Cipher Key; (c) write state cipher key; (d) hash algorithm code (MAC); (e) read state MAC secret; and (e) write state MAC secret. The remaining entries will be described in detail below.

In accordance with this embodiment of the present invention, whenever a general application alert (for example, an SSL alert), or any other general application protocol-level message (for example, an SSL protocol-level message), is detected in a TCP packet by unit 1004 filtering, the TCP packet is sent to CPU 1005 for processing.

CPU 1005 will end a general application session (for example, an SSL session) if it detects TCP connection termination messages following a general application alert message (for example, an SSL alert message).

Bulk Data

In accordance with one embodiment of the present invention, unit 1006 performs general application processing (for example, encryption/decryption) on application data for a general application session (for example, an SSL session). In accordance with this embodiment of the present invention, unit 1006 is embodied as a hardware logic unit that itself is implemented in an FPGA, although other implementations are possible including, for example, and without limitation, a standard network processor unit (NPU), a central processing unit (CPU), or an application-specific integrated circuit (ASIC).

In accordance with this embodiment of the present invention, unit 1006 accesses the general application Connection State (for example, the SSL Connection State) and the TCP Connection State to obtain information needed to perform the general application processing function (for example, the encryption/decryption function), and to obtain information needed to modify the TCP state seq and ack numbers in the manner described above. After that, the general application processed (for example, decrypted/encrypted) and modified TCP packet is incorporated into a frame, and the frame is forwarded to the appropriate one of the server/client, respectively.

General application system 1000 might order TCP packets, since, as was described above, general application processing might require an ordered stream (for example, encryption/decryption requires an ordered stream—for example, this is required by the CBC mode. Thus, if general application system 1000 receives TCP packets out of order, they cannot be forwarded. There are at least two options for handling this situation. A first option is to drop out-of-order packets, and wait for them to be resent in order. This first option is advantageous since it reduces buffering. In time, the receiver's TCP layer routines will request a resend since, as far as they are concerned, the out-of-order packets will appear to have been dropped. A second option is to buffer the TCP packets, and to wait for a TCP packet that should have been sent previously to be resent. This second option requires buffering, and as a result, is more complex than the first option. In accordance with one embodiment of the present invention, the first option is implemented in unit 1006.

As is well known to those of ordinary skill in the art, a TCP packet can contain any number of general application messages (for example, SSL messages), or it may contain a piece of a general application message (for example, an SSL message). As was described above, TCP packets are sent to unit 1006 for processing. In accordance with this embodiment of the present invention, whenever a TCP packet contains one general application message (for example, an SSL message), the bulk application data processing is handled by unit 1006. On the other hand, whenever unit 1006 determines that an inbound TCP packet contains a portion of a general application message (for example, an SSL message—in practice, this determination is made for the first inbound TCP packet of the SSL message), or more than one general application message (for example, SSL message), unit 1006 will forward the inbound TCP packet to CPU 1005 for bulk application data processing. In addition, unit 1006 will set a “punt” bit in the Client Hash Table. Whenever unit 1006 processes an inbound TCP packet, it will check the Client Hash Table for the particular connection, and examine its “punt” bit. If the “punt” bit is set, unit 1006 will forward the inbound TCP packet to CPU 1005 for processing. In this manner, in one such embodiment, CPU 1005 can gather multiple inbound TCP packets together in order to provide one general application message (for example, one SSL message). After CPU 1005 has received the entire general application message (for example, the entire SSL message), processed it, and forwarded it to the server, it will clear the “punt” bit so that unit 1005 may resume normal operation. In another such embodiment, CPU 1005 groups the information in the inbound TCP packets in order and groups the information into blocks. Then, CPU 1005 can process the information, on a block by block basis, to generate TCP packets that it will send to the server to speed up transmission. In this case, whenever the last TCP packet relating to the general application message (for example, the SSL message) arrives, it will contain the appropriate preliminary data (for example, the signature—if one is used for the particular version of SSL). If the preliminary data (for example, the signature) is bad, CPU 1005 can cause the session to be dropped in the manner described herein.

In accordance with this embodiment of the present invention, in general, whenever any condition causes unit 1006 to send a TCP packet to CPU 1005 for processing (see above), unit 1006 will send all subsequent traffic coming from the same sender to CPU 1005 for processing to make sure, for example, that TCP packets forming a general application message (for example, an SSL message) are processed in order. If this were not done, processing of subsequent TCP packets by unit 1006, might get out of order since unit 1006 (if embodied in logic) might operate faster than CPU 1005. Normal processing of TCP packets from the particular sender by unit 1006 can resume whenever CPU 1005 catches up with the sender (this is guaranteed to occur because of the TCP window size functionality which will inhibit the sending of TCP packets if the sender's window has been filled by unacknowledged packets). To effectuate this coordination, as was described above, whenever unit 1006 forwards a TCP packet to CPU 1005, it will set the “punt” bit in the Client Hash Table. Further, whenever a TCP packet arrives, and unit 1006 accesses the Client Hash Table for a pointer to the TCP Connection State for the associated connection and finds the “punt” bit set in the Client Hash Table, it will forward the TCP packet to CPU 1005 for processing. In addition, whenever CPU 1005 catches up, it will reset the punt bit so that unit 1006 will resume processing TCP packets from the particular sender.

In a case where one outbound general application message (for example, one plaintext message) spans multiple TCP packets, since instead of waiting to form one general application message (for example, one SSL message—as would occur in a prior art, proxy mode agent with SSL running on a TCP/IP stack of the server), unit 1006 can create a separate general application message (for example, a separate SSL message) for each TCP packet without waiting to receive the entire general application message (for example, the entire plaintext message). As a result, the client will receive more general application headers and trailers (for example, SSL headers and trailers) than it would if there were one general application (for example, one SSL message). Nevertheless, the client will still assemble the TCP packets into a single general application (for example, a single SSL message). Thus, the application (for example, a web browser) receives the exact same data it would have received if the TCP packets were collected to enable a single general application message (for example, a single SSL message) to be formed (this is because the general application code (for example, the SSL code) in the client strips off the headers/trailers, and passes the payload up to the application layer). Consequently, instead of receiving 16 Kbytes of data wrapped in one general application (for example, one SSL message), the client receives ten (10) 1.5 Kbyte TCP packets each wrapped in a general application (for example, a general SSL message). Advantageously, such an embodiment of the present invention eliminates the need to buffer the whole message (for example, to be able to calculate an SSL length, the SSL length is in the SSL header) before sending the first TCP packet. Note that this approach of sending through TCP packets as they arrive and not waiting to obtain an entire general application message (for example, an entire SSL message) may also be used in a proxy-mode agent.

As is well known to those of ordinary skill in the art, processing TCP packets (for example, encryption) in the outbound direction increases the size of the TCP packets. As a result, this could produce fragmentation, or multiple segments. Multiple segments are problematic because they may end up complicating the non-proxy behavior of general application system 1000.

As set forth in the following quote from page 233 of the book entitled “TCP/IP Illustrated, Volume 1—The Protocols” by W. Richard Stevens, published by Addison-Wesley, 1994:

The maximum segment size (MSS) is the largest “chunk” of data that TCP will send to the other end. When a connection is established, each end can announce its MSS. The values we've seen have all been 1024. The resulting IP datagram is normally 40 bytes larger: 20 bytes for the TCP header and 20 bytes for the IP header.

Some texts refer to this as a “negotiated” option. It is not negotiated in any way. When a connection is established, each end has the option of announcing the MSS it expects to receive. (An MSS option can only appear in a SYN segment.) If one end does not receive an MS option from the other end, a default of 536 bytes is assumed. (This default allows for a 20-byte IP header and a 20 byte TCP header to fit into a 576 byte IP datagram.)

In general, the larger the MSS the better, until fragmentation occurs, (This may not always be true. . . . ) A larger segment size allows more data to be sent in each segment, amortizing the cost of the IP and TCP headers. When TCP sends a SYN segment, either because a local application wants to initiate a connection, or when a connection request is received from another host, it can send an MSS value up to the outgoing interface's MTU, minus the size of the fixed TCP and IP headers. For an Ethernet this implies an MSS of up to 1460 bytes. Using IEEE 802.3 encapsulation (Section 2.2), the MSS could go up to 1452 bytes.

One solution is to adjust the MSS advertised by the client by subtracting, for example and without limitation, thirty-three (33) bytes from it in accordance with the method disclosed in patent application entitled “Optimizing Layer I/Layer J Connections in a Network Having Intermediary Agents, Ser. No. 09/560,951 Filed Apr. 27, 2000, which application is commonly assigned with the present application and which application is incorporated herein by reference. For example, in accordance with this method, this number is the size of an SSL header (5), plus the maximum signature size (20), plus an allowance for padding (8). In accordance with this embodiment of the present invention, adjusting MSS is performed at TCP connection establishment, and is performed by CPU 1005.

General Application System Flowchart

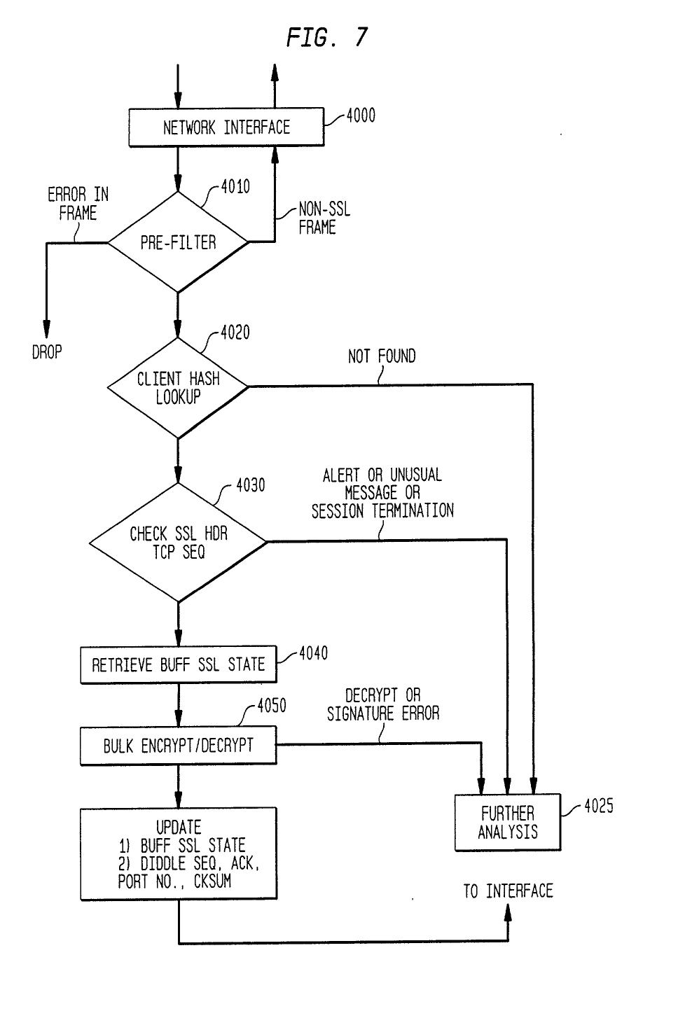

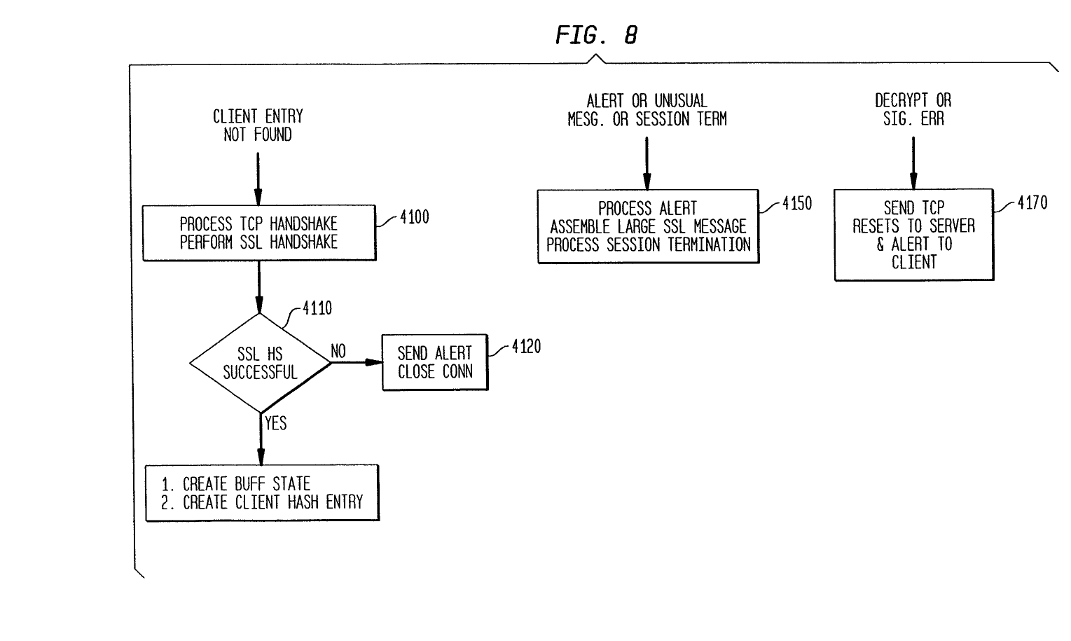

FIG. 7 shows a flowchart of operation of general application system 1000 shown in FIG. 4. As shown in FIG. 7, messages are received by, and sent from, general application system 1000 using a network interface. A message received by a network interface at box 4000 of FIG. 7, is passed to box 4010 of FIG. 7 for pre-filtering. At box 4010, if an error in the frame is detected, the TCP packet is dropped; if the frame is a non-general application frame (for example, a non-SSL frame), control is transferred to box 4000 so a network interface can send the TCP packet onto the network to the appropriate destination; otherwise, control is transferred to box 4020 of FIG. 7. At box 4020, the Client Hash Table is accessed to determine whether a TCP connection and a general application session (for example, an SSL session) have been set up for this TCP packet. If so, control is transferred to box 4030 of FIG. 7, otherwise, control is transferred to box 4025 of FIG. 7 for further analysis (the operation of box 4025 is described below in conjunction with FIG. 8).

At box 4030, the general application header (for example, the SSL header) and the TCP sequence number of the TCP packet are examined. If the TCP packet contains a general application alert message (for example, an SSL alert message), or an unusual message, or a TCP connection termination message, control is transferred to box 4025 of FIG. 7, otherwise, control is transferred to box 4040 of FIG. 7. At box 4040, the TCP Connection State and the general application Connection State (for example, the SSL Connection State) are retrieved (in a manner described in detail herein), and control is transferred to box 4050 of FIG. 7. At box 4050, the general application bulk data processing (for example, the bulk data encryption/decryption process) is carried out. If a general application process error (for example, a decryption error) or a general application preliminary data (for example, signature error) is detected, control is transferred to box 4025 of FIG. 7, otherwise, control is transferred to box 4060 of FIG. 7. At box 4060: (a) the TCP Connection State and the general application Connection State (for example, the SSL Connection State) are updated (in a manner described in detail herein); (b) the seq number, the ack number, and the port number of the TCP packet are adjusted (in a manner described in detail herein); (c) the checksum for the TCP packet is recomputed; and (d) control is transferred to box 4000 so a network interface can send the TCP packet onto the network to the appropriate destination.

FIG. 8 shows a detailed flowchart of the operation of box 4025 shown in FIG. 7. As shown in FIG. 8, control is transferred to box 4100 whenever an entry does not exist in the Client Hash Table for a particular TCP packet. At box 4100, TCP connection establishment is processed and general application handshake (for example, SSL handshake) is performed (in a manner described in detail herein). After that, control is transferred to box 4110 of FIG. 8. At box 4110, a determination is made to see whether the TCP connection establishment and the general application handshake (for example, the SSL handshake) were successful. If so, control is transferred to box 4130 of FIG. 8, otherwise, control is transferred to box 4120 of FIG. 8. At box 4120, a general application alert message (for example, an SSL alert message) is sent to the client, followed by TCP connection termination messages. At box 4130, a TCP Connection State and a general application Connection State (for example, an SSL Connection State) are created, and an entry is made in the Client Hash Table.

As further shown in FIG. 8, control is transferred to box 4150 whenever a general application alert message (for example, an SSL alert message), or an unusual message, or a TCP connection termination message is received. At box 4150, the general application alert message (for example, the SSL alert message) is processed, large general application message (for example, SSL messages) are processed, or session termination messages are processed.

As still further shown in FIG. 8, control is transferred to box 4170 whenever there is a general application processing error (for example, a decryption error) or a general application preliminary data error (for example, a signature error). At box 4170, TCP reset messages are sent to the server, and a general application alert message (for example, an SSL alert message) is sent to the client.

Physical Implementation

In accordance with one embodiment of the present invention, general application system 1000 can be implemented as a blade/card that can plug into a host system, can process from about 2000 (SSL messages)/sec to about 5000 (SSL messages)/sec, and can decrypt messages at line speed. In addition, blades/cards can be combined in a four blade/card system that can process from about 8000 (SSL messages)/sec to about 20000 (SSL messages)/sec. In accordance with one or more embodiments of the present invention, use of inventive, general application system 1000 in an SSL application relieves a server of all SSL processing so that it can simply service plain HTTP requests. Advantageously, such an embodiment of general application system 1000 can be placed as a “bump in the wire” somewhere in front of the server, most likely in front of an Internet traffic manager (ITM), also known in the art as a load balancer. This configuration has at least three important benefits. The first benefit is that it can service general application traffic (for example, SSL traffic) for several servers, with no need to modify either the server's hardware configuration, or to change the server's software in a significant way. The second benefit arises from the fact that, for an SSL application, the ITM will see traffic in the clear. As a result, the ITM can make more intelligent decisions to provide overall improvement to the site. The third benefit arises from the fact that the inventive, general application system is not a proxy agent (i.e., it does not establish connections; it merely modifies existing connections), so that TCP traffic is modified on the flight. This reduces buffering requirements, and enables the most time consuming aspects of general application processing (for example, SSL processing), namely general application handshake (for example, SSL handshake) and general application processing (for example, bulk encryption), to be accelerated, for example, in hardware.

General Application Processing (For Example, Bulk Application) State Machine

Overview

FIG. 5 shows a general case wherein: (a) client 2000 sends a packet with TCP sequence number seq to general application system 1000; (b) general application system 1000 processes (for example, decrypts) the data and (for the reasons described in detail above) changes the TCP sequence number from seq to seq′; and (c) general application system 1000 sends the altered TCP packet to server 2010. In addition, as shown in FIG. 5, (a) server 2010 sends a packet with TCP acknowledgment number ack ′ to general application system 1000; (b) general application system 1000 processes (for example, encrypts) the data and (for the reasons described in detail above) changes the TCP acknowledgment number from ack′ to ack; and (c) general application system 1000 sends the altered TCP packet to client 2000.

As one can readily appreciate from this, general application system 1000 does not control correspondence between TCP packets sent and acknowledgments received. As a result, in accordance with one embodiment of the present invention, general application system 1000 stores an ack offset (i.e., the difference between the acknowledgment number, ack′, in the TCP packet sent from the receiver, for example, the server, and the acknowledgment number, ack, corresponding to ack′ that general application system 1000 will send to the sender, for example, the client) for each TCP packet it has forwarded to the receiver, for example, the server. As one of ordinary skill in the art can readily appreciate, general application system 1000 would need to store this ack offset to enable it to modify any ack′ that it may receive from the receiver, for example, the server. In such an embodiment, whenever general application system 1000 receives an ack′ from, for example, server 2010, general application system 1000 takes this as an indication to free up memory of all stored offsets before that point, i.e., prior to ack′. There would be an exception to this however, i.e., whenever the TCP ack packet general application system 1000 sends back to client 2000 gets dropped. Methods for dealing with this situation are described below.

In an alternative of this embodiment, the number of outstanding TCP packets (i.e., TCP packets that have been sent from general application system 1000 to, for example, the server, but for which no acknowledgment has been received by general application system 1000) can be limited. In practice, as has been described above, the limit is a function of the number of TCP packets that can fit into a TCP window. Thus, whenever the TCP window is filled, no data gets sent, and general application system 1000 will have an opportunity to catch up. Although general application system 1000 can have control over the size of the TCP window (for example, by spoofing the window size option), there still may be many small TCP packets that go through general application system 1000 which require storage of many ack offsets. In such a case, in accordance with such an embodiment, once a TCP ack offset table overflows its n entries (for example and without limitation, n=16), general application system 1000 could compensate by dropping TCP packets.

The following describes further embodiments of the present invention that are driven by the fact that, in accordance with the TCP protocol, a previously sent TCP packet may be resent. For example, whenever a TCP packet is dropped (for example, the TCP packet is lost between general application system 1000 and the client, or between general application system 1000 and the server), in accordance with the TCP protocol, that event will be detected eventually (for example and without limitation, because timers expire in a manner that is well known to those of ordinary skill in the art). Then, in accordance with the TCP protocol, a previously sent TCP packet will be resent (this action being referred to herein as a “rewind”). To properly deal with such “rewinds” that occur as a natural consequence of the TCP protocol, these further embodiments need to be able to “rewind” the TCP sequence numbers (i.e., the seq and its corresponding seq′ or the ack and its corresponding ack′), and they need to be able to “rewind” the state of the general application (for example, encryption/decryption of the messages) as well. As one can readily appreciate from the above, there is a need to “rewind” the TCP sequence numbers to have the proper translation of a received seq to seq′ or the proper translation of a received ack′ to ack, respectively. In addition, as one can readily appreciate from the above, there is a need to “rewind” the state of the general application (for example, encryption/decryption of the messages) to be able process (for example, encrypt/decrypt) the resent TCP packet.

Inventive “Rewind Methods”

One issue in implementing the “rewind” function that must be kept in mind is that a general application such as SSL generates a relatively large encryption state for a stream cipher such as, for example, the RC4 variable-key size stream cipher. For example, for RC4, the encryption state comprises a 256-byte encryption state plus two (2) additional bytes for other information that is well known to those of ordinary skill in the art, see a book entitled “Applied Cryptography, Second Edition, Protocols, Algorithms, and Source Code in C” by Bruce Schneier, John Wiley & Sons, 1996, Chapter 17, pp. 397-98.

As is well known to those of ordinary skill in the art, for a stream cipher, the keystream is independent of the plaintext. Thus, for a stream cipher such as RC4, given the RC4 state of a particular byte in a message, one can compute the RC4 state (and the key) for any other byte in the message given just its position with respect to the particular byte. In other words, if one knows the RC4 state of a byte B1 in a sequence of encrypted (or decrypted) messages, then the RC4 state (and the key) can be computed for any other byte B2 in the message, given the position of byte B2 relative to the position of byte B1 in the message, i.e., (position(B2)−position(B1). Of course, one would have to subtract all bytes in the message that are not encrypted such as, for example, bytes in SSL headers from (position(B2)−position(B1). The important thing to note, therefore, is that the computation of the RC4 state (and the key) is independent of the message itself.

This is illustrated as follows. First, to initialize the RC4 state: (a) initialize an S-box by filling it linearly S₀=0, S₁=1, . . . , S₂₅₅=255; (b) set two bytes Si and Sj to 0; and (c) fill a 256-byte array with the key, repeating the key as necessary to fill the entire array K₀, K₁, . . . , K₂₅₅. The key is five (5) bytes for export or as much as 16 bytes for other uses. Then perform the following:

j=0

for i=0 to 255;

j=(j+Sᵢ+Kᵢ) mod 256

Swap Sᵢ and Sⱼ.

Then, to generate a random byte, perform the following:

Si=(Si+1) mod 256

Sj=(Sj+S_{Si}) mod 256

swap Sᵢ and Sⱼ

t=(Sᵢ+Sⱼ) mod 256

K=Sₜ

Then, the byte K is XORed with the plaintext to produce ciphertext or XORed with the ciphertext to produce plaintext.

A “saved state” is encryption/decryption state information (also referred to herein as a cipher state) that is necessary and sufficient to enable SSL processing (i.e., encryption/decryption) of a TCP packet. The “saved state” can be “rewound” using the RC4 rewind algorithm starting with a “saved state” to obtain the “saved state” of, for example, a retransmitted packet. The RC4 rewind algorithm is:

swap S_{Si} and S_{Sj}

Sj=(Sj−S_{Si}+256) mod 256

Si=(Si−1+256) mod 256

For a block cipher such as, for example, the DES or 3DES block ciphers, since the encryption state is not independent of the message, one cannot “rewind” without the data (as was noted above, encoding/decoding a block of data requires use of encoding/decoding results from immediately previous block(s)). However, for the DES and 3DES block ciphers, the encryption state is only eight (8) bytes per block in each direction of transmission.

“Rewind Method I”

In accordance with one embodiment of the present invention, general application system 1000 updates a decryption state as each TCP packet is processed (those of ordinary skill in the art will readily appreciate that the following applies as well to a direction of transmission requiring encryption). For example, using RC4, general application system 1000 buffers (or stores) the 256-byte decryption state at all TCP packet boundaries, or, alternatively, it buffers (or stores) the actual decrypted data. These data are buffered (or stored) along with the seq and seq′ correspondence data. To understand how “Rewind Method I” works, assume, for the sake of illustration, that: (a) four (4) TCP packets have been received by general application system 1000 from, for example, client 2000; (b) general application system 1000 has performed decryption, using, for example, RC4, on these TCP packets in succession; and (c) general application system 1000 has, therefore, updated and buffered (or stored) the decryption state, for example, the 256-byte decryption state, (or alternatively, the decrypted data) for each. Assume further that TCP packet number 3 is dropped between general application system 1000 and server 2010, and, as a result, that client 2000 resends TCP packet number 3 because client 2000 has not received an acknowledgment before a timer expires. In accordance with “Rewind Method I”, general application system 1000 “rewinds” i.e., decrypts, TCP packet number 3 by: (a) (where the 256-byte decryption state is buffered (or stored) at all TCP packet boundaries) decrypting the resent TCP packet from the decryption state; or (b) (where the actual decrypted data is buffered (or stored)) retrieving the actual decrypted data.

“Rewind Method II”

To handle dropped or lost TCP packets, and to retransmit those dropped or lost TCP packets, general application system 1000 buffers (or stores) information described below; which information is buffered (or stored) in a TCP Connection State (see Table I which shows one embodiment of a TCP Connection State) and a general application Connection State (for example, an SSL Connection State—see Table II which shows one embodiment of an SSL Connection State. As described above, the TCP Connection State and the general application Connection State (for example, the SSL Connection State) are stored in storage, for example, a storage unit such as memory, that is accessible to CPU 1005 and unit 1006 shown in FIG. 4. Further, as was described above, the Client Hash Table has a pointer which points to the TCP Connection State, and as shown in Table I, the TCP Connection State has a pointer to the general application Connection State (for example, the SSL Connection State).

Variable InBackSeqPair represents a pair (InBackSeq, InBackSeq′) of TCP sequence numbers for the next expected seq number after the last TCP packet for which an acknowledgment was sent from general application system 1000 to the client (i.e., InBackSeq=seq [of the last TCP packet for which an acknowledgment was sent] plus its length). InBackSeq is the TCP sequence number of a TCP packet as it would be received by general application system 1000 from the client, and InBackSeq′ is the TCP sequence number of the TCP packet as it would be sent from general application system 1000 to the server. The variable InBackSeqPair is also referred to as a “backup state.”

A “saved state” is general application information (for example, encryption/decryption state information—also referred to herein as a cipher state) that is necessary and sufficient to enable general application processing (for example, SSL processing—i.e., encryption/decryption) of a TCP packet. The “saved state” for the “backup state” is the “saved state” for a TCP packet whose first byte has a TCP sequence number equal to InBackSeq.

Variable InMaxSeqPair represents a pair (InMaxSeq, InMaxSeq′) of TCP sequence numbers for the next expected seq number after the last TCP packet general application system 1000 sent to the server (i.e., InMaxSeq=seq [of the last TCP packet general application system 1000 sent to the server] plus its length). InMaxSeq is the TCP sequence number of a TCP packet as it would be received by general application system 1000 from the client, and InMaxSeq′ is the seq number of the TCP packet as it would be sent from general application system 1000 to the server. The variable InMaxSeqPair is also referred to as the “forward state.” The “saved state” for the “forward state” is the “saved state” for a TCP packet whose first byte has a TCP sequence number equal to InMaxSeq.

Variable OutLastAck′ is the largest outgoing ack number general application system 1000 received from the server.

As one can readily appreciate, the above-described variables correspond to operations concerning transmission from a client to a server. Similar variables, having similar meaning, are shown in Table I, and correspond to transmission from the server to the client.

For this embodiment, the “saved states” for the “backup state” and the “forward state” for the incoming and outgoing directions of transmission are stored in the general application Connection State (for example, the SSL Connection State) (see Table II).

The following relations will always be true between the above-described variables for a given direction of transmission:

InBackSeq′≦OutLastAck′≦InMaxSeq′

InBackSeq≦InMaxSeq

InBackSeq>InBackSeq′ and InMaxSeq>InMaxSeq′

Based on these variables, a TCP Connection State can only be in one of the following states:

State 1: InBackSeq′=OutLastAck′=InMaxSeq′

This state, denoted CAU (caught up), occurs whenever general application system 1000 has received an ack from the server for every TCP packet that general application system 1000 has sent it thusfar. Thus, the server is caught up with the client. As a result, general application system 1000 can update the “backup state” to refer to the TCP packet most recently sent to the server. Because general application system 1000 knows the server has already received the last TCP packet general application system 1000 sent, there is no situation in which general application system 1000 will have to re-decrypt data earlier in the connection.

State 2: InBackSeq′=OutLastAck′<InMaxSeq′

This state, denoted NAC (No Ack), occurs whenever general application system 1000 has not received any acks for any TCP packets it sent since it was in the CAU state (i.e., since receiving the last ack). This means that the server is backed up. If general application system 1000 receives a retransmission from the client in this state, there is a good chance that a TCP packet and/or an ack got lost between general application system 1000 and the server.

State 3: InBackSeq′<OutLastAck′<InMaxSeq′

This state, denoted by SAC (Some Ack), is a “steady state” and occurs whenever the server sent an ack for some of the TCP packets it received from general application system 1000, but not all. On receiving a retransmission from the client while in this state, general application system 1000 will advance the “backup state” until it reaches: (a) a CAU state (if no TCP packets are lost), or (b) a NAC state (if some TCP packets are lost or if the server is backed up).

State 4: InBackSeq′<OutLastAck′=InMaxSeq′

In accordance with this embodiment of the present invention, as soon as a connection reaches this state, general application system 1000 will set (InBackSeq, InBackSeq′) to (InMaxSeq, InMaxSeq′) to drive it to the CAU state. This means that the “backup state” becomes the last sent TCP packet.

As is well known to those of ordinary skill in the art, in an SSL application, a typical SSL message includes a message, a signature, and padding. In order for the message to be decrypted for transmission from general application system 1000 to the server, the entire SSL message must be decrypted using an appropriate encryption/decryption algorithm determined during SSL handshake (for example, see Table II) and an appropriate Cipher State to determine the padding length. Using the padding length, the signature and the message can be identified. Next, the signature can be authenticated using an appropriate authentication algorithm determined during SSL handshake and appropriate keys (for example, see Table II). Lastly, the authenticated message can be sent to the server as plaintext. Conversely, in order to encrypt a plaintext message for transmission from general application system 1000 to the client, general application system 1000 computes a signature using the appropriate authentication algorithm and the appropriate keys (for example, see Table II), pads the message and signature, adds a padding length, and encrypts the entire SSL message using the appropriate encryption/decryption algorithm and the appropriate Cipher State.

In accordance with one embodiment of the present invention, two kinds of inputs can change the state of a connection in general application system 1000: (a) an outgoing ack in a TCP packet, or (b) an incoming TCP packet. Tables III and IV show state transitions generated by a state machine for inbound traffic (the state machine for outbound traffic is equivalent); which state transitions occur in response to each of these kinds of inputs separately. Many methods are well known to those of ordinary skill in the art for implementing such a state machine. In addition, in accordance with the further embodiment of the present invention, all state transitions due to acks will be handled in unit 1006.

The following provides some explanations to help in understanding the manner in which the state machine works.

Table III

Before describing each state transition in detail in conjunction with Table III, the following provides an overview.

Whenever an outgoing message containing an Ack′ is received by general application system 1000 from the server, general application system 1000 replaces the Ack′ with the sequence number of the “backup state” (i.e., InBackSeq) or the sequence number of the “forward state” (i.e., InMaxSeq). General application system 1000 may also update its internal state, and may update the value of the last Ack′ it received so far from the server (i.e., OutLastAck′). State transitions possible upon receiving an Ack′ are:

1. NAC [symbol] CAU or SAC [symbol] CAU: if general application system 1000 receives an Ack′ for the last information sent (i.e., corresponding to the “forward state”), then general application system 1000 collapses the “backup state” to the “forward state” and advances the internal state to CAU.

2. NAC [symbol] SAC: If general application system 1000 receives an Ack′ for some, but not all of the TCP packets that it has sent to the server, it advances its state to SAC, and updates the value of the last Ack′ that it has received.

The following describes each state transition in Table III in detail.

Case 1: Ack′ refers to information in a TCP packet for which general application system 1000 has already sent an acknowledgment to the client. General application system 1000 sends the packet to the client, and sets the ack number to InBackSeq, the next seq number that general application system 1000 expects after the “backup state.”

Case 2: Ack′ refers to information in a TCP packet that general application system 1000 is expecting next. General application system 1000 sends the TCP packet to the client, and sets the ack number to InBackSeq, the next seq number that general application system 1000 expects after the “backup state.”

Case 3: Ack′ refers to information that was not sent to general application system 1000. This is an erroneous packet since the server is acknowledging data that it has not received. General application system 1000 sends the TCP packet to the client with the same error. That is, it sets the ack number to InBackSeq offset by the same amount that Ack′ exceeded InBackSeq′. Then, when the client receives this, it will detect the error and take appropriate steps to correct it.

Case 4: Ack′ refers to information that has already been acknowledged by general application system 1000 to the client (Ack′≦InBackSeq′). General application system 1000 transmits the TCP packet, and sets the ack number to InBackSeq, the next seq number that general application system 1000 expects after the “backup state.”

Case 5: Ack′ refers to information for which general application system 1000 has not yet received an acknowledgment, and for which general application system 1000 has not yet sent an acknowledgment to the client. A transition is made to SAC. OutLastAck′ is updated to Ack′. Then, general application system 1000 transmits the TCP packet to the client, and sets the ack number to InBackSeq. General application system 1000 reverts to InBackSeq because it can decrypt the packet with seq number InBackSeq (general application system 1000 would use the “backup state” information stored in the general application Connection State for example, the SSL Connection State). If general application system 1000 were to set the ack number in the TCP packet to the ack number corresponding to Ack′, and the packet got lost and was later retransmitted, general application system 1000 would not be able to decrypt it.

Case 6: Ack′ refers to the next seq number that general application system 1000 expects to receive from the client after the “forward state.” This means that the server has acknowledged receipt of all information sent by general application system 1000 to the server. A transition is made to CAU, the “forward state” becomes the “backup state,” and general application system 1000 transmits the TCP packet to the client with the ack number set to InMaxSeq, the next seq number that general application system 1000 expects to receive from the client after the “forward state.”

Case 7: Ack′ refers to information that general application system 1000 has not yet sent (this is just like case 3, an erroneous packet). However, a transition is made to CAU, the “forward state” becomes the “backup state,” and general application system 1000 transmits the TCP packet to the client with the ack number reset to the seq number expected after the “forward state” offset by the same amount that Ack′ exceeds InMaxSeq′.

Case 8: Ack′ refers to information in a TCP packet for which general application system 1000 has already sent an acknowledgment to the client. General application system 1000 sends the packet to the client, and sets the ack number to InBackSeq, the next seq number that general application system 1000 expects after the “backup state.”

Case 9: Ack′ refers to information in a TCP packet that general application system 1000 is expecting next after the “backup state.” General application system 1000 sends the TCP packet to the client, and sets the ack number to InBackSeq, the next seq number that general application system 1000 expects after the “backup state.”

Case 10: Ack′ refers to information for which general application system 1000 already received an acknowledgment. General application system 1000 transmits the TCP packet to the client, and sets the ack number to InBackSeq. General application system 1000 reverts to InBackSeq because it can decrypt the packet with seq number InBackSeq (general application system 1000 would use the “backup state” information stored in the general application Connection State for example, the SSL Connection State). If general application system 1000 were to set the ack number in the TCP packet to the ack number corresponding to Ack′, and the packet got lost and was later retransmitted, general application system 1000 would not be able to process (for example, decrypt) it.

Case 11: Ack′ refers to information for which general application system 1000 has not yet received an acknowledgment, and for which general application system 1000 has not yet sent an acknowledgment to the client. OutLastAck′ is updated to Ack′. Then, general application system 1000 transmits the TCP packet to the client, and sets the ack number to InBackSeq. General application system 1000 reverts to InBackSeq because it can decrypt the packet with seq number InBackSeq (general application system 1000 would use the “backup state” information stored in the general application Connection State for example, the SSL Connection State). If general application system 1000 were to set the ack number in the TCP packet to the ack number corresponding to Ack′, and the packet got lost and was later retransmitted, general application system 1000 would not be able to decrypt it.

Case 12: Ack′ refers to the next seq number that general application system 1000 expects to receive from the client after the “forward state.” A transition is made to CAU, the “forward state” becomes the “backup state,” and general application system 1000 transmits the TCP packet to the client with the ack number set to InMaxSeq, the next seq number that general application system 1000 expects to receive from the client after the “forward state.”

Case 13: Ack′ refers to information that general application system 1000 has not yet sent (this is just like cases 3 and 7, an erroneous packet). However, a transition is made to CAU, the “forward state” becomes the “backup state,” and general application system 1000 transmits the TCP packet to the client with the ack number reset to the seq number expected after the “forward state,” offset by the same amount that Ack′ exceeds InMaxSeq′.

Table IV

Before describing each state transition in detail in conjunction with Table IV, the following provides an overview.

Whenever an incoming message containing encrypted data is received by general application system 1000 from the client, it could belong to one of the following categories: (a) a new, in-order packet; (b) a new, out-of-order packet; (c) a complete, in-order retransmit (i.e., it contains no new data); (d) a partial, in-order retransmit (i.e., some old data and some new data); and (e) an out-of-order retransmit.

General application system 1000 determines the category of an incoming TCP packet by comparing the packet's sequence number with the sequence numbers of the “forward state” and the “backup state.” Out-of-order packets are dropped in accordance with this embodiment of the present invention, but could be reassembled in alternative embodiments. In-order packets are processed using the “backup state” (i.e., InBackSeq) if it is a retransmit, or using the “forward state” (i.e., InMaxSeq) if it is a new packet. The state transitions possible upon receiving an incoming TCP packet are:

1. SAC [symbol] NAC: if general application system 1000 receives a retransmit of a packet that has been Acked by the server (but not by general application system 1000 to the client), then general application system 1000 transitions from the SAC to the NAC state.

2. CAU [symbol] NAC: On arrival of a new, in-order packet, general application system 1000 transitions from the CAU state to the NAC state.

The following describes each state transition in Table IV in detail.

Case 1: Seq refers to information for which general application system 1000 has already received an acknowledgment from the server and sent the acknowledgment to the client. This retransmit was probably caused by a loss of an Ack sent by general application system 1000 to the client, and hence, the subsequent retransmission by the client. General application system 1000 sends a ReACK request to the server (see Note 2 following Table IV). The ReACK request causes the server to resend an acknowledgment, which acknowledgment is passed to the client.

2: Seq refers to new, in-order information that general application system 1000 has not yet received. General application system 1000 processes the information (i.e., decrypts it and verifies the signature), and sends the decrypted information to the server. Also, it updates InMaxSeq to the next expected sequence number, and changes the state of the system to NAC.

Case 3: Seq refers to new, but out-of-order information. In accordance with this embodiment of the present invention, general application system 1000 drops this information.

Case 4: This case is handled in the same manner that case 1 is handled.

Case 5: Seq refers to a retransmit of information that general application system 1000 processed earlier, but for which general application system 1000 has not yet received an ack. This information may be lost between system 1000 and the server. General application system 1000 processes the information and sends it to the server. However, general application system 1000 does not update the “backup state” because it has not yet received an ack for this packet.

Case 6: Seq refers to retransmitted information, but not the next expected information. Since general application system 1000 does not have the general application Connection State information to enable it to be processed, as a result, the retransmitted information is simply turned into a ReACK request to update OutLastAck′ (i.e., the last Ack received by general application system 1000).

Case 7: Seq refers to new, in-order information. This case is handled in the same that case 2 is handled.

Case 8: This case is handled in the same manner that case 3 is handled.

Case 9: This case is handled in the same manner that cases 1 and 4 are handled.

Case 10: Seq refers to a retransmission of information that general application system 1000 processed earlier, and for which information general application system 1000 has received an ACK from the server. General application system 1000 processes the information, and advances the “backup state” (i.e., InBackSeq, InBackSeq′) to the new information. If the value of seq′ plus the length of the decrypted information is equal to the last ack received (i.e., OutLastAck′), the general application system 1000 state is updated to NAC, otherwise, general application system 1000 continues to be in the SAC state.

Case 11: Seq refers to a retransmission of information for which general application system 1000 has not yet received an ack from the server. This case is handled in the same manner that case 5 is handled.

Case 12: This case is handled in the same manner that case 6 is handled.

Case 13: This case is handled in the same manner that cases 2 and 7 are handled.

Case 14: This case is handled in the same manner that cases 3 and 8 are handled.

TABLE I
TCP Connection State

| | | |
|---|---|---|
| Incoming | InBackSeq | InBackSeq' |
| | InMaxSeq | InMaxSeq' |
| | | OutLastAck' |
| Outgoing | OutBackSeq' | OutBackSeq |
| | OutMaxSeq' | OutMaxSeq |
| | InLastAck' | |

Pointer to associated SSL Connection State

TABLE II
SSL Connection State

| | |
|---|---|
| Cipher Code | Read state Cipher Key |
| Encryption/Decryption | |
| Cipher State (“saved state”) | Write state Cipher Key |
| Incoming backup state | |
| Cipher State (“saved state”) | |
| (Incoming forward state) | |
| Cipher State (“saved state”) | |
| (Outgoing backup state) | |
| Cipher State (“saved state”) | |
| (Outgoing forward state) | |
| Hash Algorithm Code | |
| (MAC) | |
| SSL Seq Number for | Read state MAC secret |
| Backup | |
| SSL Seq Number for | Write state MAC secret |
| Forward | |

TABLE III
Ack Transition Table
Ack' is the acknowledgment number received by general application system 1000.

| | | | | Update | | |
|---|---|---|---|---|---|---|
| | | | | InBackSeq, | | |
| | Cur. | | Next | InMaxSeq, | Ack in TCP | Output to |
| | State | Value of Ack' | State | OutLastAck | Header | Network |
| 1 | CAU | Ack' < | CAU | None | Ack = InBackSeq | Send |
| | | InBackSeq' | | | | |
| 2 | CAU | Ack' = | CAU | None | Ack = InBackSeq | Send |
| | | InBackSeq' | | | | |
| 3 | CAU | Ack' > | CAU | None | Ack = InBackSeq + | Send |
| | | InBackSeq' | | | (Ack' − | |
| | | | | | InBackSeq') | |
| 4 | NAC | Ack' ≦ | NAC | None | Ack = InBackSeq | Send |
| | | InBackSeq' | | | | |
| 5 | NAC | Ack' > | SAC | OutLastAck' = | Ack = InBackSeq | Send |
| | | InBackSeq', | | Ack' | | |
| | | and Ack' < | | | | |
| | | InMaxSeq' | | | | |
| 6 | NAC | Ack' = | CAU | InBackSeq' = | Ack = InMaxSeq | Send |
| | | InMaxSeq' | | InMaxSeq' = | | |
| | | | | OutLastAck' | | |
| | | | | Update “saved | | |
| | | | | state” | | |
| 7 | NAC | Ack' > | CAU | InBackSeq' = | Ack = InMaxSeq + | Send |
| | | InMaxSeq' | | InMaxSeq' = | (Ack' − | |
| | | | | OutLastAck' | InMaxSeq') | |
| | | | | Update “saved | | |
| | | | | state” | | |
| 8 | SAC | Ack' < | SAC | None | Ack = InBackSeq | Send |
| | | InBackSeq' | | | | |
| 9 | SAC | Ack' = | SAC | None | Ack = InBackSeq | Send |
| | | InBackSeq' | | | | |
| 10 | SAC | Ack' ≦ | SAC | None | Ack = InBackSeq | Send |
| | | OutLastAck' | | | | |
| 11 | SAC | Ack' > | SAC | OutLastAck' = | Ack = InBackSeq | Send |
| | | OutLastAck', | | Ack' | | |
| | | and Ack' < | | | | |
| | | InMaxSeq' | | | | |
| 12 | SAC | Ack' = | CAU | InBackSeq' = | Ack = InMaxSeq | Send |
| | | InMaxSeq' | | InMaxSeq' = | | |
| | | | | OutLastAck' | | |
| | | | | Update “saved | | |
| | | | | state” | | |
| 13 | SAC | Ack' > | CAU | InBackSeq' = | Ack = InMaxSeq + | Send |
| | | InMaxSeq' | | InMaxSeq' = | (Ack' − | |
| | | | | OutLastAck' | InMaxSeq') | |
| | | | | Update “saved | | |
| | | | | state” | | |

TABLE IV
Seq Transition Table
Seq is the sequence number an incoming packet and len is its length.

| | | | | | | Output |
|---|---|---|---|---|---|---|
| | | | | Update | | on |
| | | | | InBackSeq, | | Network/ |
| | Cur. | | Next | InMaxSeq, | Causing | Action |
| | State | Value of Seq | State | OutLastAck | Condition | by CPU |
| 1 | CAU | Seq < | CAU | None | Retransmit due to | Generate |
| | | InBackSeq | | | loss of Ack | ReACK |
| | | | | | between agent and | request |
| | | | | | client | |
| 2 | CAU | Seq = | NAC | InMaxSeq = | New in-order | Send |
| | | InBackSeq | | Seq + len, | packet received | |
| | | | | update | | |
| | | | | InMaxSeq' | | |
| 3 | CAU | Seq > | CAU | None | New out-of-order | Drop |
| | | InBackSeq | | | packet received | |
| 4 | NAC | Seq < | NAC | None | Retransmit due to | Generate |
| | | InBackSeq | | | loss of data | ReACK |
| | | | | | between agent and | request |
| | | | | | server | |
| 5 | NAC | Seq = | NAC | None (do not | Retransmit due to | Send |
| | | InBackSeq | | update | loss of data | |
| | | | | InBackSeq | between agent and | |
| | | | | since it cannot | server | |
| | | | | be ahead of | | |
| | | | | OutLastAck') | | |
| 6 | NAC | Seq > | NAC | None | Retransmit, out- | Generate |
| | | InBackSeq and | | | of-order packet | ReACK |
| | | Seq < | | | received | request |
| | | InMaxSeq | | | | |
| 7 | NAC | Seq = | NAC | InMaxSeq = | New in-order | Send |
| | | InMaxSeq | | Seq + len, | packet received | |
| | | | | update | | |
| | | | | InMaxSeq' | | |
| 8 | NAC | Seq > | NAC | None | New, out-of- | Drop |
| | | InMaxSeq | | | order packet | |
| | | | | | received | |
| 9 | SAC | Seq < | SAC | None | Retransmit due to | Generate |
| | | InBackSeq | | | data loss between | ReACK |
| | | | | | agent and client | request |
| 10 | SAC | Seq = | SAC/ | InBackSeq = | Retransmit due to | Send |
| | | InBackSeq, | NAC | Seq + len, | data loss between | |
| | | Seq' + len' ≦ | | InBackSeq' = | agent and server | |
| | | OutLastAck' | | Seq' + len' | | |
| 11 | SAC | Seq = | SAC | Do not update | Retransmit due to | Send |
| | | InBackSeq, | | InBackSeq | data loss between | |
| | | Seq' + len' > | | | agent and server | |
| | | OutLastAck' | | | | |
| 12 | SAC | Seq > | SAC | None | Out-of-order | Drop |
| | | InBackSeq, and | | | transmit | |
| | | Seq < | | | | |
| | | InMaxSeq | | | | |
| 13 | SAC | Seq = | SAC | InMaxSeq = | New in-order | Send |
| | | InMaxSeq | | Seq | packet received | |
| 14 | SAC | Seq > | SAC | None | New, out-of-order | Drop |
| | | InMaxSeq | | | packet received | |
| Notes for Table IV: | | | | | | |
| Note 1: There are two methods for processing a case where general application system 1000 receives a packet with Seq = InBackSeq in cases 5 and 11. | | | | | | |
| Method 1. As described in above, the packet is processed (i.e., decrypted), and forwarded to the server. However, InBackSeq is not updated to the new value. This will work efficiently if the server has lost just one packet. In such a case, as soon as the retransmitted packet is sent to the server, general application system 1000 will receive an ACK for InMaxSeq', | | | | | | |
| # which cause a transition to the CAU state without having to retransmit all the packets from InBackSeq to InMaxSeq. However, if the server has lost n (>1) packets, general application system 1000 will have to wait for n retransmissions from the client to get to the CAU state. Method 2 handles this case in a more efficient way. | | | | | | |
| Method 2. First, collapse the InMaxSeq state to InBackSeq. Next, process the packet, send the processed packet to the server, set InMaxSeq equal to (Seq + len), set InMaxSeq' equal to (Seq' + len'), and go to NAC state. This method has the advantage that if the server has lost multiple packets in flight, it will get all the packets from only one retransmission from the client. | | | | | | |
| In one embodiment, one can use a combination of the above-described two methods, for example, one can use Method 1 if (InBackSeq - InMaxSeq) is within a first predetermined range, and use Method 2 when it is within a second predetermined range, which first and second ranges can be determined by routine experimentation involving optimization of performance. | | | | | | |
| Note 2: ReACK request | | | | | | |
| A ReACK request involves sending a 0 byte TCP packet to the server with a sequence number less that the last ACK that general application system 1000 sent. In accordance with the TCP protocol, this will cause the server to respond with the ACK of the latest packet that it has received so far. General application system 1000 then uses this last ACK to update the OutLastAck' | | | | | | |
| # value with this ACK. Thus, in cases 1, 4, 6, and 9 in Table IV, instead of simply dropping the packet, general application system 1000 one can choose to generate this special request when it will be advantageous to update the OutLastAck' state. | | | | | | |

In a further embodiment of Rewind Method II, one would utilize a multiplicity of backed up states, where the multiplicity is greater than the two backed up states described above (i.e., the “backup state” and the “forward state”). In one such embodiment, one would utilize, for example and without limitation, three backed up states, i.e., an extra backed up state between the “backup state” and the “forward state” of the above-described embodiment. In such an embodiment, whenever, an acknowledgment is received for the intermediate state, the “backup state” would become the former intermediate state and the intermediate state would become the former “forward state.” As one can readily appreciate from this, such an embodiment might advantageously enhance throughput.

“Rewind Method III”

As was described above, in accordance with Rewind Method II, non-proxy agent general application system 1000 stores information relating to a general application connection (for example, an SSL connection) and a TCP connection in accessible storage, for example, memory, for use in handling retransmission caused by TCP packets being lost or dropped between the agent and the client, or between the agent and the server. As was further described above, the stored information comprises a combination of the general application Connection State (for example, the SSL Connection State) described above and the TCP Connection State described above. As was still further described above, the agent stored such information for a “backup state” corresponding to a TCP sequence number pair (InBackSeq, InBackSeq′) and a “forward state” corresponding to a TCP sequence number pair (InMaxSeq, InMaxSeq′) for each connection. As was yet still further described above, the “backup state” was advanced whenever a TCP packet corresponding to the “backup state” was retransmitted from the client (see Table IV, case 10), or whenever an Ack′ for the “forward state” was received from the server (see Table III, cases 6-7 and 12-13).

In accordance with Rewind Method III, the “backup state” corresponding to InBackSeqPair, i.e., (InBackSeq, InBackSeq′), the “forward state” corresponding to InMaxSeqPair, i.e., (InMaxSeq, InMaxSeq′), and OutLastAck′ are still utilized as described above in conjunction with Rewind Method II. In addition, in accordance with Rewind Method III, the agent (general application system 1000) also buffers (or stores): (a) the TCP sequence numbers of some (or all) of the TCP packets it receives between the “backup state” and the “forward state,” and (b) information related to general application sequence numbers (for example, SSL sequence numbers) of some (or all) of the TCP packets it receives between the “backup state” and the “forward state.” These information, i.e., TCP sequence numbers and general application sequence number information (for example, SSL sequence number information) will be referred to below as “packet marker information,” and these packet marker information is buffered (or stored) in a queue keyed by TCP connection.

In accordance with Rewind Method III, if the agent (general application system 1000) has received an acknowledgment of some of the TCP packets that it has processed (i.e., it is in the SAC state described above in conjunction with Rewind Method II), then the agent recomputes the “saved state” information for the “backup state” corresponding to (InBackSeq, InBackSeq′) to make it the same as the “saved state” information for the last Ack′ it received, which last Ack′ is denoted as OutLastAck′. In other words, in accordance with Rewind Method III, the agent transitions from the SAC state to the NAC state without waiting for a retransmitted TCP packet, or an Ack′ for the “forward state” as is the case for Rewind Method II. As was described above in conjunction with Rewind Method II, the agent always acknowledges the “backup state” to the sender, for example, the client. However, in accordance with Rewind Method III, by more frequently advancing the “backup state,” the sender, for example, the client, will receive more up-to-date Acks. Advantageously, this will reduce the number of TCP packets retransmitted by the sender. Although Rewind Method III requires more storage, for example, memory, than Rewind Method II, Rewind Method III will increase network throughput.

The following sets forth the steps required for Rewind Method III for a stream cipher.

1. During bulk processing of a connection, the agent (general application system 1000), for example, unit 1006 described above, stores a “backup state” and a forward state, where the same definitions apply here that were used above in conjunction with Rewind Method II.

2. In addition, in one embodiment of Rewind Method III for use in conjunction with a stream cipher such as RC4, the agent, for example, unit 1006, buffers (or stores) “packet marker information,” i.e., it maintains a queue of TCP sequence numbers and SSL sequence numbers of all packets it processes between InBackSeq and InMaxSeq. Here InMaxSeq refers to the oldest entry in the queue, and InBackSeq refers to the youngest entry in the queue.

In order to “rewind” the decryption state from: (a) a TCP packet having packet marker information (c,d) where c is the TCP sequence number and d is the SSL sequence number of an SSL header appearing in the TCP packet for that TCP connection; and (b) a second TCP packet having packet marker information (a,b) where a is the TCP sequence number and b is the SSL sequence number of an SSL header appearing in the TCP packet, one would have to decrypt or encrypt (depending on the direction of transmission) a number of bytes equal to (c-a)-5*(d-b). As those of ordinary skill in the art readily appreciate, for the SSL protocol, an SSL header comprises five (bytes) which are not encrypted/decrypted. Although this embodiment of the present invention is described in conjunction with this specific example, it is not limited to this protocol. In addition, those of ordinary skill in the art readily appreciate that one TCP frame may comprise one SSL header, many SSL headers, or no SSL header. In order to account for this, the second piece of data in the packet marker information may simply indicate a difference between the SSL sequence number for a TCP packet and the SSL sequence number for the succeeding TCP packet to automatically provide the proper number of encrypted or decrypted bytes in the formula given above.

For a block cipher such as, for example, DES or 3DES, as was described above, one cannot “rewind” without the data. However, since the “saved states” are relatively small (eight (8) bytes in each direction), in accordance with one embodiment of Rewind Method III, the agent (general application system 1000) buffers (or stores) all of the intermediate “saved states” (SSL Connection States) between the “backup state” and the “forward state” together with the TCP sequence information. In this case, the “rewind” merely entails accessing the relevant block of buffered data corresponding to the appropriate TCP sequence number.

3. Whenever the agent (general application system 1000) receives an Ack′ for a TCP packet between InBackSeq and InMaxSeq, it replaces the Ack′ with the Ack for InBackSeq.

4. However, at the same time, the agent (general application system 1000) works on advancing InBackSeq towards OutLastAck′ using the packet marker information in an “offline mode,” that is, without waiting for a retransmission of the backup state corresponding to InBackSeq as was the case for Rewind Method II and without waiting for an Ack′ for the forward state corresponding to InMaxSeq′ as was the case for Rewind Method II. Instead, whenever, the agent (general application system 1000) receives an Ack′, for example, having a value X, using the packet marker information for TCP sequence numbers between InBackSeq and X, the agent (general application system 1000) advances the backup state from InBackSeq to X by computing the “saved state” information. As described above, for a stream cipher such as RC4, the “saved state” information is computed in accordance with the description above, and for a block cipher such as DES or 3DES, the “saved state” information is retrieved in accordance with the description above. Then the packet marker information between InBackSeq and X is discarded from the queue.

One method of implementing the above-described movement of the backup state is to have unit 1006 perform the “offline mode” computation itself. A further method of implementing the above-described movement of the backup state is to provide another hardware unit that performs the “offline mode” computation in parallel with unit 1006. A still further method is to have unit 1006 set the punt bit (described in detail above) for all retransmitted packets so that they will be handled in CPU 1005.

In an alternative embodiment of Rewind Method III, step 4 above would be performed before replying to the client. In this alternative embodiment, the agent (general application system 1000) would advance the backup state to OutLastAck′ using the packet marker information as described above. Then, the agent (general application system 1000) would replace the Ack′ with the new backup state.

In accordance with one embodiment of the present invention, two kinds of inputs can change the state of a connection in general application system 1000: (a) an outgoing ack in a TCP packet, or (b) an incoming TCP packet. Tables V and VI indicate the various possible inputs received by the agent (general application system 1000), and its responses thereto (the situation for outbound traffic is equivalent). Many methods are well known to those of ordinary skill in the art for implementing such responses. In addition, in accordance with the further embodiment of the present invention, all responses due to acks can be handled in unit 1006.

The following provides some explanations to help in understanding the manner in which the responses are effected.

Table V

The following describes each response in Table V in detail.

Case 1: Ack′ refers to information in a TCP packet for which general application system 1000 has already sent an acknowledgment to the client. General application system 1000 sends the packet to the client, and sets the ack number to InBackSeq, the next seq number that general application system 1000 expects after the “backup state.”

Case 2: Ack′ refers to information in a TCP packet that general application system 1000 is expecting next. General application system 1000 sends the TCP packet to the client, and sets the ack number to InBackSeq (the next seq number that general application system 1000 expects after the “backup state”).

Case 3: Ack′ refers to information that was not sent to general application system 1000. This is an erroneous packet since the server is acknowledging data that it has not received. General application system 1000 sends the TCP packet to the client with the same error. That is, it sets the ack number to InBackSeq offset by the same amount that Ack′ exceeded InBackSeq′. Then, when the client receives this, it will detect the error and take appropriate steps to correct it.

Case 4: Ack′ refers to information for which general application system 1000 has already received an acknowledgment from the server, and sent the acknowledgment to the client. This Ack′ is probably caused by an error at the server. General application system 1000 transmits a ReACK request to the server. The ReACK request causes the server to resend an acknowledgment, which acknowledgment is passed to the client.

Case 5: Ack′ refers to the next seq number that general application system 1000 expects to receive from the client after the “forward state.” This means that the server has acknowledged receipt of all information sent by general application system 1000 to the server. The “backup state” becomes the “forward state,” and general application system 1000 transmits the TCP packet to the client with the ack number set to InMaxSeq, the next seq number that general application system 1000 expects to receive from the client after the “forward state.”

Case 6: Ack′ refers to information that general application system 1000 has not yet sent (this is just like case 3, an erroneous packet). The “backup state” becomes the “forward state,” and general application system 1000 transmits the TCP packet to the client with the ack number reset to the seq number expected after the “forward state” offset by the same amount that Ack′ exceeds InMaxSeq′.

Case 7: Ack′ refers to information in a TCP packet for which general application system 1000 has not yet sent an acknowledgment to the client. General application system 1000 sends the packet to the client, sets the ack number to InBackSeq (the next seq number that general application system 1000 expects after the “backup state”), updates OutLastAck′, works the “backup state” to OutLastAck,′ and discarding packet marker information as it proceeds (as set forth above).

Table VI

Whenever an incoming message containing encrypted data is received by general application system 1000 from the client, it could belong to one of the following categories: (a) a new, in-order packet; (b) a new, out-of-order packet; (c) a complete, in-order retransmit (i.e., it contains no new data); (d) a partial, in-order retransmit (i.e., some old data and some new data); and (e) an out-of-order retransmit.

General application system 1000 determines the category of an incoming TCP packet by comparing the packet's sequence number with the sequence numbers of the “forward state” and the “backup state.” Out-of-order packets are dropped in accordance with this embodiment of the present invention, but could be reassembled in alternative embodiments. In-order packets are processed using the “backup state” (i.e., InBackSeq) if it is a retransmit, or using the “forward state” (i.e., InMaxSeq) if it is a new packet.

The following describes each response in Table VI in detail.

Case 1: Seq refers to information for which general application system 1000 has already received an acknowledgment from the server and sent the acknowledgment to the client. This retransmit was probably caused by a loss of an Ack sent by general application system 1000 to the client, and hence, the subsequent retransmission by the client. General application system 1000 sends a ReACK request to the server (see Note 2 following Table IV). The ReACK request causes the server to resend an acknowledgment, which acknowledgment is passed to the client.

Case 2: Seq refers to new, in-order information that general application system 1000 has not yet received. General application system 1000 processes the information (i.e., decrypts it and verifies the signature), and sends the decrypted information to the server. Also, it updates InMaxSeq to the next expected sequence number, and saves the packet marker information.

Case 3: Seq refers to new, but out-of-order information. In accordance with this embodiment of the present invention, general application system 1000 drops this information.

Case 4: This case is handled in the same manner that case 1 is handled.

Case 5: Seq refers to a retransmit of information that general application system 1000 processed earlier, but for which general application system 1000 has not yet received an ack. This information may be lost between general application system 1000 and the server. General application system 1000 processes the information, and sends it to the server. However, general application system 1000 does not update the “backup state” because it has not yet received an ack for this packet.

Case 6: Seq refers to retransmitted information, but not the next expected information. General application system 1000 “rewinds” the “saved state” in the manner described in detail above, encrypts/decrypts, saves the packet marker information, and transmits the rewound TCP packet.

Case 7: Seq refers to new, in-order information. This case is handled in the same manner that case 2 is handled.

Case 8: This case is handled in the same manner that case 3 is handled.

TABLE V
Ack Response Table
Ack' is the acknowledgment number
received by general application system 1000.

| | | Update | | |
|---|---|---|---|---|
| | | InBackSeq, | | |
| | | InMaxSeq, | Ack in TCP | Output to |
| | Value of Ack' | OutLastAck | Header | Network |
| 1 | Ack' < | None | Ack = InBackSeq | Send |
| | InBackSeq' | | | |
| 2 | Ack' = | None | Ack = InBackSeq | Send |
| | InBackSeq' | | | |
| 3 | Ack' > | None | Ack = InBackSeq | Send |
| | InBackSeq' | | + (Ack' − | |
| | | | InBackSeq') | |
| 4 | Ack' ≦ | None | | Generate |
| | OutLastAck' | | | ReACK |
| | | | | request |
| 5 | Ack' = | InBackSeq' = | Ack = InMaxSeq | Send |
| | InMaxSeq' | InMaxSeq' = | | |
| | | OutLastAck' | | |
| | | Update “saved | | |
| | | state” | | |
| 6 | Ack' > | InBackSeq' = | Ack = InMaxSeq + | Send |
| | InMaxSeq' | InMaxSeq' = | (Ack' − | |
| | | OutLastAck' | InMaxSeq') | |
| | | Update “saved | | |
| | | state” | | |
| 7 | Ack' ≧ | Update | Ack = InBackSeq | Send |
| | OutLastAck' | OutLastAck' | | |
| | and Ack' < | work the | | |
| | InMaxSeq' | “backup state” | | |
| | | towards | | |
| | | OutLastAck', | | |
| | | discarding | | |
| | | packet marker | | |
| | | information on | | |
| | | the way | | |

TABLE VI
Seq Response Table
Seq is the sequence number an incoming packet and len is its length.

| | | Update | | Output on |
|---|---|---|---|---|
| | | InBackSeq, | | Network/ |
| | Value | InMaxSeq, | Causing | Action |
| | of Seq | OutLastAck | Condition | by CPU |
| 1 | Seq < | None | Retransmit due | Generate |
| | InBackSeq | | to loss of Ack | ReACK |
| | | | between agent | request |
| | | | and client | |
| 2 | Seq = | InMaxSeq = | New in-order | Send |
| | InBackSeq | Seq + len, | packet received | |
| | | update | | |
| | | InMaxSeq' | | |
| | | save packet | | |
| | | marker | | |
| | | information | | |
| 3 | Seq > | None | New out-of- | Drop |
| | InBackSeq | | order packet | |
| | | | received | |
| 4 | Seq < | None | Retransmit due | Generate |
| | InBackSeq | | to loss of data | ReACK |
| | | | between agent | request |
| | | | and server | |
| 5 | Seq = | None (do | Retransmit due | Send |
| | InBackSeq | not update | to loss of data | |
| | | InBackSeq | between agent | |
| | | since it | and server | |
| | | cannot be | | |
| | | ahead of | | |
| | | OutLastAck') | | |
| 6 | Seq > | “Rewind” the | Retransmit, | Send |
| | InBackSeq | “saved state” | out-of-order | |
| | and Seq < | save the packet | packet received | |
| | InMaxSeq | marker | | |
| | | information | | |
| 7 | Seq = | InMaxSeq = | New in-order | Send |
| | InMaxSeq | Seq + len, | packet | |
| | | update | received | |
| | | InMaxSeq' | | |
| 8 | Seq > | None | New, out-of- | Drop |
| | InMaxSeq | | order packet | |
| | | | received | |

“Rewind Method IV”

Rewind Method IV eliminates the need for the sender (for example, the client) to retransmit TCP packets other than those that have been lost in transit. Further, in accordance with Rewind Method IV, the agent (general application system 1000) does not maintain a “backup state,” and only maintains a “forward state” for a connection. As a result, it always acknowledges the last ack it receives from a recipient, for example, the server. This is different from Rewind Methods II and III which, as was described in detail above, acknowledge the “backup state.” If any TCP packets are lost between the agent and the sender, or between the agent and the recipient, eventually the sender will retransmit the lost TCP packet. In that case, the agent uses the “forward state,” and packet marker information to determine the “saved state” of the lost TCP packet. As was described in detail above, this determination is done by computation for a stream cipher such as RC4, and is done by lookup for a block cipher such as DES or 3DES.

In accordance with Rewind Method IV, during bulk processing of a connection, the agent, for example unit 1006 described in detail above, stores packet marker information between the last Ack′ received (the sequence number corresponding to OutLastAck′) and InMaxSeq′, where the same definitions apply here that were used above in conjunction with Rewind Method II.

Thus, in accordance with Rewind Method IV, as shown in Table VII for an embodiment used with a stream cipher such as RC4, a TCP Connection State comprises the following information for each direction of transmission, i.e., incoming transmission (a transmission from client to server) and outgoing transmission (a transmission from server to client):

a) the last TCP sequence number acknowledged by a receiver (denoted as set forth in detail above by: (i) OutLastAck′ for incoming traffic, and (ii) InLastAck′ for outgoing traffic)

b) a packet marker information queue: each entry in this queue is a pair of TCP sequence numbers, which TCP sequence numbers correspond to the TCP sequence number of every TCP packet received with an offset TCP sequence number greater than the last OutLastAck′. The pair (InMaxSeq, InMaxSeq′) for incoming traffic denotes the relevant information for the most recently received TCP packet (or the youngest TCP packet). The pair (InSeq1, InSeq1′) denotes the original and offset TCP sequence numbers (plus len and len′, respectively) of the next most recently received TCP packet (or the next youngest TCP packet), and the pair (InSeqn, InSeqn′) denotes the original and offset TCP sequence numbers (plus len and len′, respectively) of the oldest TCP packet with an offset sequence number greater than OutLastAck′. Equivalent definitions hold for outgoing traffic. In an alternative embodiment of the present invention, packet marker information is not saved in the queue for TCP packets that do not include an SSL header.

Further, in accordance with Rewind Method IV, as shown in Table VIII for an embodiment used with a stream cipher such as RC4, a general application Connection State (for example, an SSL Connection State) comprises the following information:

A Cipher code and a MAC code indicating which SSL cipher is used, and which MAC algorithm is used. This information is the same for incoming and outgoing directions of transmission.

For incoming transmission:

a) a Cipher Key, which may or may not include an initial vector, and the MAC secret

b) a Cipher State of the most recent TCP packet decrypted by the agent (general application system 1000, by bulk engine 1006 or CPU 1005)

c) a queue of SSL sequence numbers for the TCP packets received with a TCP sequence number greater than the largest TCP sequence number unacknowledged by the receiver. Recall that an SSL sequence number is used to verify the MAC in each message, and that the SSL sequence number is incremented for every SSL message processed. The list of SSL sequence numbers are stored because each TCP segment may contain more than one SSL message, or there might be one SSL message than spans multiple TCP segments. Note that, for memory efficiency, only the difference between two consecutive SSL sequence numbers are stored.

For Outgoing Traffic:

a) the Cipher Key and the Mac Secret

b) a Cipher state of the most recent TCP packet encrypted by the agent (general application system 1000, by bulk engine 1006 or CPU 1005)

Note that SSL sequence number information are not stored for each of the TCP packet marker information (although they could be). This can occur in accordance with this embodiment, because SSL system 1000 can ensure that there is exactly one SSL message for each TCP packet when an outgoing message is encrypted, thereby obviating the need to maintain a history of SSL sequence numbers (although this does not have to the rule).

Overview

Whenever the agent receives an Ack′ that is greater than OutLastAck′, the agent acknowledges the equivalent Ack to the sender, and discards all packet marker information between OutLastAck′ and Ack′. In other words, in general, the agent always acknowledges the equivalent value of the most recent Ack′ it receives.

Whenever a TCP packet (a seq with data from the sender or an Ack′ from the recipient) gets lost between the agent and the sender, or between the agent and the recipient, it will be retransmitted. If the agent receives a retransmitted TCP packet, it determines the “saved state” of the retransmitted TCP packet using the “saved state” of the “forward state” (InMaxSeq), and the packet marker information. For a stream cipher such as RC4, it then decrypts/encrypts the retransmitted TCP packet, and forwards it. One method of implementing this is to have the bulk engine, i.e., unit 1006, perform the computation itself. A further method of implementing this is to provide another hardware unit that performs the computation in parallel with unit 1006. A still further method is to have unit 1006 set a punt bit for all retransmitted TCP packets so they will be handled in CPU 1005.

The following pseudo-code describes how an embodiment of Rewind Method IV processes an ack for an outgoing TCP packet, i.e., a TCP packet sent from the server to the client (the procedure for processing an ack for an incoming TCP packet is equivalent).

| proc adjustOutboundAck: | | | |
|---|---|---|---|
| | ackSeq' | | <− TCP Ack' number of the input TCP packet |
| | bTcpcb | | <− pointer to the TCP Connection State (i.e., InMaxSeq') |
| | inMarker | | <− the input marker queue in the TCP Connection State |
| | sslMarker | | <− the SSL sequence queue in the TCP Connection State |
| | if (ackSeq' > bTcpcb −> InMaxSeq') | | |
| | // | this is equivalent to cases 3, 7, and 13 for Rewind Method II | |
| | begin | | |
| | | replace ackSeq by (bTcpcb−> InMaxSeq + (ackSeq' − bTcpcb−> | |
| | InMaxSeq') | | |
| | | deque all the packet marker information from inMarker | |
| | | deque all the SSL sequence numbers from sslMarker | |
| | | transmit the TCP packet with TCP sequence number ackSeq | |
| | | return; | |
| | end | | |
| | // | Search for the TCP packet in the inMarker queue | |
| | // | Whenever the agent receives an Ack' that is greater than OutLastAck' | |
| | // | the agent acknowledges the equivalent Ack to the sender, and discards all | |
| | // | packet marker information between OutLastAck' and Ack' | |
| | count <−# of elements in the inMarker queue | | |
| | while (count > 0) | | |
| | begin | | |
| | | if (inMarker[count].Seq' <= ackSeq') | |
| | | begin | |
| | | | replace ackSeq by inMarker[count].Seq |
| | | | deque count − 1 elements from the inMarker |
| | | | deque count − 1 elements from sslMarker |
| | | | transmit the TCP packet with TCP sequence number ackSeq |
| | | | return |
| | | end | |

| | count <− count − 1 |
|---|---|
| end | |
| // | If no matching packet found, set ackSeq equal to the |
| // | offset value of the oldest packet marker information in the queue |
| | ackSeq = = inMarker[oldest].Seq |
| | transmit the TCP packet with TCP sequence number ackSeq |
| | return |

end proc adjustOutboundAck

The following pseudo-code describes how an embodiment of Rewind Method IV processes an incoming TCP packet containing data, i.e., a TCP packet sent from the client to the server (the procedure for processing an outgoing TCP packet containing data is equivalent).

proc adjustInboundTcpSeq:

tcpSeq <− TCP Seq Number of the input TCP packet
bTcpcb <− pointer to the TCP Connection State (i.e., InMaxSeq)
if (tcpSeq = = bTcpcb −> InMaxSeq)
begin

| | |
|---|---|
| // | This is the common case, the next expected TCP packet |
| // | has arrived, i.e., an in-order packet |

| decrypt the TCP packet using the current cipher state for InMaxSeq | |
|---|---|
| replace tcpSeq with bTcpcb −> InMaxSeq' (known after decryption) | |
| enque (tcpSeq + len, tcpSeq' + len') at top of the packet marker | |
| | information queue |

transmit the decrypted TCP packet
return

end
if (tcpSeq > btcpcb −> InMaxSeq)
begin

| | |
|---|---|
| // | This TCP packet is out of order, drop it |

drop frame
return

| end | |
|---|---|
| // | Handle a retransmitted TCP packet: |
| // | Whenever a TCP packet (a seq with data from the sender or an Ack' |
| // | from the recipient) gets lost between the agent and the sender, or |
| // | between the agent and the recipient, it will be retransmitted. If the |
| // | agent receives a retransmitted TCP packet, it determines the “saved state” |
| // | of the retransmitted TCP packet using the “saved state” of the “forward |
| // | state” (InMaxSeq) and the packet marker information. It then |
| // | decrypts/encrypts the retransmitted TCP packet, and forwards it. |

| | |
|---|---|
| inMarker | <− the input packet marker information queue |
| youngest | <− index of youngest packet marker information in inMarker |
| sslMarker | <− the SSL sequence number queue |
| count | <− # of elements in inMarker |
| maxSeq | <− bTcpcb −> InMaxSeq |

| // | rewindBytes represents the number of bytes to “rewind” starting |
|---|---|
| // | from the “forward state” |
| rewindBytes <− 0 | |
| while (count) | |
| begin | |
| // | numSdlHdr represents the number of SSL headers received |
| // | between the retransmitted TCP packet and the “forward state” |
| // | as described above, this is needed to determine the number of bytes |
| // | that need to be decrypted for “rewind” from the “forward state” back |
| // | to the retransmitted TCP packet |

| numSslHdr <− sslMarker[youngest] − sslMarker[count] | |
|---|---|
| if (inMarker[count].Seq = = tcpSeq) | |
| begin | |
| | replace tcpSeq by inMarker[count].Seq' |

| | |
|---|---|
| // | this algorithm assumes that each SSL header comprises |
| // | five (5) bytes, but the present invention is not limited by this |

rewindBytes <− (maxSeq − inMarker[count].Seq) −

numSslHdr * 5

| | |
|---|---|
| // | The method for the rewind was described in detail for RC4 above |

Rewind the SSL Cipher State by rewindBytes
Decrement the SSL Sequence number by numSslHdr

| | |
|---|---|
| // | The method for the decryption was described in detail for RC4 above |

decrypt the TCP packet using this rewound SSL Cipher state

and sslMarker[count] as the SSL sequence number

| | |
|---|---|
| | transmit the decrypted TCP packet |
| | return; |
| end | |

| | count <− count − 1 |
|---|---|
| end | |
| // | If this is reached, the server has already acknowledged |
| // | this TCP packet, so just drop it |

drop TCP packet
return

end adjustInboundTcpSeq

In a further embodiment of Rewind Method IV, the decryption algorithm for the retransmitted TCP packet is carried out at the same time as the rewind algorithm is being carried out. As one can readily appreciate, the bytes in the retransmitted algorithm are decrypted from the bottom of the retransmitted packet to the top. As one can readily appreciate, this should save computation time since the retransmitted TCP packet will be decrypted at the same time that the “rewind” is finished.

For a block cipher such as, for example, DES or 3DES, as was described in detail above, instead of rewinding the cipher state, one merely retrieves the initial vectors from the packet marker information.

TABLE VII
TCP Connection State

| | | |
|---|---|---|
| Incoming | OutLastAck′ | |
| Incoming Packet Marker | InMaxSeq | InMaxSeq′ |
| Information Queue | | |
| | InSeq1 | InSeq1′ |
| | InSeq2 | InSeq1′ |
| | . . . | . . . |
| | InSeqn | InSeqn′ |
| Outgoing | InLastAck′ | |
| Outgoing Packet Marker | OutMaxSeq | OutMaxSeq' |
| Information Queue | | |
| | OutSeq1 | OutSeq1′ |
| | OutSeq2 | OutSeq2′ |
| | . . . | . . . |
| | OutSeqm | OutSeqm′ |

Pointer to associated SSL Connection State

TABLE VIII
SSL Connection State

| | Cipher Code | MAC Code |
|---|---|---|
| Incoming | Cipher Key | Read MAC Secret |
| | Cipher State for | |
| | InMaxSeq | |
| SSL Sequence Queue | InSeq1 | InSeq2 |
| | InSeq3 | InSeq4 |
| | . . . | InSeqn |
| Outgoing | Cipher Key | Write MAC Secret |
| | Cipher State for | |
| | OutMaxSeq | |

Long General Application Messages (For Example, Long SSL Messages)

The following describes an embodiment of the present invention that handles general application messages (for example, SSL messages) that either span multiple TCP segments or are required to be buffered by the general application agent for any other reason, such as those application messages that are modified at the general application agent The handling of either of these cases is similar because in each case, the general application agent needs to keep the TCP state of the server and client to be consistent even when it has some application data buffered. One can assume, for the sake of the description, that this is an exceptional case for normal system behavior.

Background

Long general application messages only raise an issue for messages originating from an end of a connection that requires general application processing. For example, long SSL messages only raise an issue for messages originating from the client, since they are encrypted. As is well known, in accordance with the SSL protocol, the maximum length of an SSL message is 16K bytes, and a typical window size could be larger or smaller than the maximum SSL message size. Further, as will be described in detail below, this embodiment of the present invention needs to be aware of the window size. This is needed (in accordance with the TCP protocol) so that the window size does not shrink without a receiver's receiving any more data.

Two ways to handle these long general application messages (for example, SSL messages) are: (a) a buffering method where the full general application message (for example, the full SSL message) is buffered (for example, with SSL, the signature is verified, and the SSL message is sent to the server); and (b) a packetized method where fractions of the general application message (for example, fractions of the SSL message) are sent to the receiver (for example, the server), as they are received (for example, with SSL, the signature is processed whenever it is received).

An advantage of the packetized method is that it does not require much memory, and it does not require an embodiment of an intermediary agent to become a TCP system (i.e., it remains in a non-proxy mode). One problem with the packetized method is that a malicious agent could modify the message contents, and the general application header (for example, the SSL header), so that an application request can be received by the server (and possibly acted upon) before the preliminary data (for example, the signature) is verified. However, since a malicious agent still has to work on a general application processed message (for example, an encrypted message), it is still very unlikely that the message will contain anything meaningful.

Buffering Method

The following will describe the buffering method as its behavior relates to: (a) SSL processing (encryption and MAC computation of the message); and (b) TCP processing.

SSL Processing as an Example of General Application Processing

In accordance with this embodiment of the present invention, each piece of the long SSL message will be decrypted, as it is received, and a running MAC will be computed. Because of the MAC computation, the long SSL message must be processed in blocks of 64 bytes. For each long SSL message, this means there can be up to 63 bytes that need to be saved for processing when the next segment of the long SSL message arrives. These bytes will be referred to as the “ragged edge.”

In addition to the above-described information that is stored in the SSL Connection State (see Tables II and VIII, and the descriptions set forth above), in accordance with this embodiment of the present invention, the following information is also stored in the SSL Connection State as a long SSL message is processed:

a) a total expected length of the message (for example, 2 bytes);

b) a length up to the last fully processed block (for example, 2 bytes);

c) a partial signature as of the last processed block (for example, 20 bytes);

d) a length of the ragged edge (for example, 1 byte); and

e) the ragged edge bytes themselves (for example, 63 bytes).

Thus, for this embodiment, 88 bytes of storage are required, plus storage for a pointer to a dynamically allocated structure to hold the decrypted buffers for the message data. This information is stored in addition to the cipher state corresponding to the next expected block: a 256 byte RC4 state, or an 8 byte DES/3DES state (this information is stored already as part of the SSL Connection State—for InMaxSeq).

The SSL processing of long SSL messages could be performed by CPU 1005 or by bulk encryption/decryption unit 1006, both of which are described above in conjunction with FIG. 4. To do this processing of long SSL messages, CPU 1005 or bulk encryption/decryption unit 1006 will concatenate signatures, i.e., a MAC computation must start a partial signature, and CPU 1005 or bulk encryption/decryption unit 1006 must save the partial signature when it is done with a block.

TCP Processing

In accordance with this embodiment of the present invention, there are no rewinds for long general application messages (for example, long SSL messages). In addition, an embodiment of the present invention tracks the window size offered by both ends of a connection at all times. To do this, the window size is added to the TCP Connection State (see Tables I and VII, and the description set forth above), and is updated on all Acks, i.e., the window size used is the window size of the last packet sent by the server to the client, see Table IX.

In accordance with one embodiment of the present invention, an inventive agent “holds” the client after receiving the entire long general application message (for example, the entire long SSL message)—i.e., inhibits the client from sending data to the server. For example, the agent can do this in one embodiment by sending a window size of zero with an Ack (in accordance with the TCP protocol, upon receipt thereof, the client will not send any more data). In addition, the agent will set the InSeq TCP sequence number to that for the end of the long general application message (for example, the long SSL message) after the entire long general application message (for example, the long SSL message) has been received (the agent does not update InMax until the last packet for the long general application message (for example, the long SSL message) has been received).

Message Reception

In accordance with this embodiment of the present invention, while the inventive agent is receiving a long general application message (for example, a long SSL message) from the client, it will not forward it to the server. However, in some instances it may be desirable to forward Acks contained in the long general application message (for example, the long SSL message) to the server (i.e., strip the packets of data, and just send the Acks), or at least the first Ack, to avoid unnecessary retransmissions from the server.

If the server is caught up (i.e., the inventive agent has received an Ack from the server for every TCP packet that the inventive agent has sent to the server thus far—for an embodiment using Table VII for the TCP Connection State, this means that the packet marker count is zero), in one embodiment, the inventive agent sends Acks to the client as the messages are received therefrom, and in another embodiment, the inventive agent holds all Acks. Thus, the inventive agent can either send an Ack to the client after the reception of any message, or it can implement delayed Acks (for example, in accordance with the TCP protocol, the agent can Ack every, for example, second message, or the agent can Ack in accordance with a timer). In accordance with the first embodiment, the inventive agent will send Acks upon message reception from the client, and these Acks will contain the current window size offered by the server.

On the other hand, if the server is not caught up, and the client retransmits some messages before the long general application message (for example, the long SSL message) is completely received by the inventive agent, the inventive agent will forward those other messages to the server. Again, only when the server is caught up to the beginning of the long general application message (for example, the long SSL message) does the inventive agent start Ack-ing to the client what the inventive agent has buffered.

Message Forwarding

In accordance with this embodiment of the present invention, the inventive agent will not start forwarding the long general application message (for example, the long SSL message) to the server until the server has caught up to the beginning of the long general application message (for example, the long SSL message). As the inventive agent forwards the general application processed data stream (for example, the decrypted and verified data stream) to the server, the inventive agent may send Acks to the client, even though the client already received these Acks from the inventive agent. This will not be a problem provided that the inventive agent sends a window size of zero (to hold the client from sending any more data). When the entire long general application message (for example, the long SSL message) has been sent to the server, and the inventive agent has received an Ack indicating that the entire stream has been received, the inventive agent will resume “normal” function.

In this state, for transmission of the long general application message (for example, the long SSL message) to the server, the inventive agent will have a retransmit timer enabled, and it will also count Acks from the server to detect the need for fast retransmissions.

State Transition Table

This section describes: (a) state transitions of the inventive agent when handling long general application messages (for example, long SSL messages); and (b) actions the inventive agent will take for each possible packet it receives from the server and from the client. Table IX sets forth the actions taken by the inventive agent for incoming packets from the network.

States

In accordance with one embodiment of the present invention, the inventive agent can be in one of the following three states at any time:

Packet Forwarding (FWD) State: The inventive agent is in the FWD state whenever there is no data buffered by the inventive agent. In this state, all incoming general application messages (for example, incoming SSL messages) that are fully contained in one TCP packet are processed in the manner described above, and forwarded without buffering.

Long Message Accumulate (ACC) State: The inventive agent is in the ACC state when it starts receiving a long general application message (for example, a long SSL message) from the client. The inventive agent remains in the ACC state until the current long general application message (for example, the current long SSL message) is completely received by the inventive agent.

Long Message Transmit (XMT) State: Once the inventive agent has received the entire long general application message (for example, the long SSL message), it starts transmitting the general application processed data (for example, the decrypted data) to the server. During this process, the inventive agent is in the XMT state. The inventive agent remains in the XMT state until the server acknowledges all the data from the long general application message (for example, the long SSL message). Once the last Ack for the current long general application message (for example, the long SSL message) is received, if the inventive agent has any buffered data left (from the next general application message (for example, the next SSL message), it goes back to the ACC state, otherwise it goes to the FWD state.

All the state transitions and actions for the inventive agent are described below. A general application message (for example, an SSL message) is called a Short general application Message (for example, a Short SSL Message) if it is completely contained in an incoming TCP packet.

TABLE VIII
Long SSL Message Transition Table

| | Incoming | Incoming | | | | Output |
|---|---|---|---|---|---|---|
| Current | Message | Message | Next | | Window | to |
| State | Source | Contents | State | Action | Size Used | Network |
| FWD: no | client | short SSL | FWD | decrypt and | record | forward |
| long SSL | | message | | forward | window | decrypted |
| message | | | | | size from | message |
| (LSM) | | | | | client | to server |
| pending | | | | | | |
| FWD | client | LSM, first | ACC | decrypt, | use last | Ack to |
| | | packet | | buffer, and | recorded | client |
| | | | | Ack packet | window | |
| | | | | to client | size from | |
| | | | | | server | |
| FWD | server | any | FWD | encrypt and | record | forward |
| | | | | forward | window | to client |
| | | | | | size from | |
| | | | | | server | |
| ACC: long | client | LSM | ACC | decrypt, | use last | Ack to |
| SSL | | packet, not | | buffer, and | recorded | client |
| message | | including | | Ack packet | window | |
| received | | entire MAC | | to client | size from | |
| | | | | | server | |
| ACC | client | LSM packet | XMT | decrypt, | use window | Ack to |
| | | including | | verify MAC, | size = 0 in | client, |
| | | entire MAC | | Ack packet | Ack to | first |
| | | and no bytes | | to client, and | client, and | decrypted |
| | | from next | | forward to | last | packet to |
| | | SSL | | server | recorded | server |
| | | message | | | client | |
| | | | | | window | |
| | | | | | size in | |
| | | | | | message to | |
| | | | | | server | |
| ACC | client | LSM packet | XMT | decrypt, | use window | Ack to |
| | | with entire | | verify MAC, | size = 0 in | client, |
| | | MAC and | | Ack | Ack to | and first |
| | | some bytes | | completed | client, and | decrypted |
| | | from next | | SSL message | last | packet to |
| | | SSL message | | packet to | recorded | server |
| | | | | client, | client | |
| | | | | forward | window | |
| | | | | verified | size in | |
| | | | | message to | message to | |
| | | | | server, buffer | server | |
| | | | | start of next | | |
| | | | | SSL message | | |
| ACC | client | retransmitted | ACC | rewind state, | no action | forward |
| | | short SSL | | decrypt, and | | to server |
| | | message | | forward | | |
| ACC | client | retransmitted | ACC | drop | no action | none or |
| | | packet of | | | | Ack, if |
| | | current LSM: | | | | necessary |
| | | with/without | | | | * |
| | | MAC | | | | |
| ACC | client | retransmitted | ACC | drop | no action | none or |
| | | packet of an | | | | Ack, if |
| | | earlier LSM | | | | necessary |
| | | | | | | * |
| ACC | server | any | ACC | encrypt and | use last | forward |
| | | | | forward | recorded | to client |
| | | | | | window | |
| | | | | | size | |
| XMT: | client | new data | XMT | drop, since | no action | none |
| decrypted | | | | client is | | |
| LSM being | | | | sending data | | |
| transmitted | | | | after window | | |
| to server | | | | size = 0 | | |
| XMT | server | partial Ack | XMT | encrypt (if | set window | forward |
| | | (with or | | data) and | size in | Ack to |
| | | without | | forward, send | packet to | client, |
| | | data) of | | more data to | client = 0, | forward |
| | | LSM | | server | use last | more |
| | | | | | recorded | LSM data |
| | | | | | window | to server |
| | | | | | size for the | |
| | | | | | client in the | |
| | | | | | message | |
| | | | | | sent to the | |
| | | | | | server | |
| XMT | server | Ack of last | ACC | encrypt (if | restore | forward |
| | | byte in | | data) and | window | to client |
| | | LSM, but | | forward | size to the | |
| | | some | | | one | |
| | | buffered | | | specified by | |
| | | data | | | the server | |
| | | remains on | | | | |
| | | agent | | | | |
| XMT | server | Ack of last | FWD | encrypt and | restore | forward |
| | | byte of | | forward | window | to client |
| | | LSM, no | | | size to the | |
| | | buffered | | | one | |
| | | data in the | | | specified by | |
| | | server | | | the server | |

* It may be necessary to send an Ack if the inventive agent is using delayed Acks in accordance with one aspect of the TCP protocol. In addition, it may be necessary to send an Ack if there is a missing packet in transmission from the client, and the inventive agent wants to instigate a retransmission of the missing packet.

Those skilled in the art will recognize that the foregoing description has been presented for the sake of illustration and description only. As such, it is not intended to be exhaustive or to limit the invention to the precise form disclosed. For example, many of the above-described features of the inventive, non-proxy mode agent could be used to fabricate embodiments of a proxy mode agent.

In a still further embodiment of the present invention, general application system 1000 shown in FIG. 4 could be implemented in a distributed system where the various functions described above could be embodied in a distributed multi-processor system. In such an embodiment, the various parts would communicate over busses or over a communications network such as, for example and without limitation, a local network. In addition, in one such embodiment, the two directions of communication could also be handled by two different systems, wherein each system could itself be distributed.

Lastly, although the detailed description set forth above discussed communications between a client and a server, it should be appreciated by those of ordinary skill in the art that the present invention is not limited thereto. In fact, it is within the scope of the present invention to include embodiments that relate to communication between a first and a second end.

What is claimed is:

1. A method for handling an application in a communication between a first end and a second end involving an application layer, a transport layer, and a network layer, which method comprises steps of:
receiving network layer packets from the first end of the communication, which packets contain application information provided using application layer processing;
processing the application information using application layer processing; and
transmitting network layer packets toward the second end of the communication, which packets contain information resulting from the application layer processing.

2. The method of claim 1 which further comprises steps of:
receiving network layer packets from the second end of the communication, which packets contain further application information provided using application layer processing;
processing the further application information using application layer processing; and
transmitting network layer packets toward the first end of the communication, which packets contain information resulting from the application layer processing.

3. The method of claim 2 which further comprises steps of:
transmitting transport layer information from the first end to the second end; and
transmitting transport layer information from the second end to the first end.

4. The method of claim 3 which further comprises steps of:
receiving application layer session messages from the first end; and
responding to the first end to the application layer session messages.

5. The method of claim 4 wherein the steps of receiving and responding to application layer session messages comprises a step of establishing an application layer session with the first end.

6. The method of claim 3 which further comprises steps of:
maintaining information, or information derived from, at least some transport layer information sent from the first end to the second end; and
maintaining information, or information derived from, at least some transport layer information sent from the second end to the first end.

7. The method of claim 6 which further comprises a step of associating network packets with the communication using at least some of the maintained information obtained from transport layer information and at least some of the maintained information obtained from network layer information.
